(19) United States
(12) Patent Application Publication
(10) Pub. No.: US 2012/0112524 A1
(43) Pub. Date: May 10, 2012

(54) BRAKE CONTROL APPARATUS

(75) Inventors: Taichi SHIBATA, Atsugi-shi (JP); Yohei MASUI, Kawasaki-shi (JP)

(73) Assignee: Hitachi Automotive Systems, Ltd.

(21) Appl. No.: 13/274,391

(22) Filed: Oct. 17, 2011

(30) Foreign Application Priority Data
Nov. 10, 2010 (JP) 2010-251752

(51) Int. Cl. B60T 13/16

(52) U.S. Cl. 303/10

(57) ABSTRACT

In a brake control apparatus employing a pump for producing a flow of brake fluid in a hydraulic brake circuit, an electric motor for driving the pump, and a control unit, the control unit includes a motor speed estimation section configured to estimate a revolution speed of the motor based on an inter-terminal voltage of the motor and a motor characteristic of the motor. Also provided is a motor speed control section configured to control a speed of the motor based on the motor speed estimated by the motor speed estimation section and a preset target motor speed.

### TECHNICAL FIELD

The present invention relates to a brake control apparatus, and specifically to a motor speed estimation device configured to estimate a revolution speed of an electric motor that drives a pump.

### BACKGROUND ART

In recent years, there have been proposed and developed various motor speed estimation devices configured to estimate a revolution speed of an electric motor. One such motor speed estimation device has been disclosed in Japanese Patent Provisional Publication No. 2008-295120 (hereinafter is referred to as “JP2008-295120”). The motor speed estimation device disclosed in JP2008-295120 is applied to an automotive brake control unit, for estimating a revolution speed of an electric motor configured to drive a pump that draws a brake fluid in a brake circuit into itself and forces the brake fluid out. The operation of the pump motor is controlled based on the estimated motor speed. The motor speed estimation device of JP2008-295120 is configured in a manner so as to estimate the motor speed based on a motor counter-electromotive force (in other words, an induced voltage developed in an inductive circuit of the motor) during a motor de-energization period, and also to estimate the motor speed based on both a battery voltage, serving as an electric power source, and a motor inter-terminal voltage during a motor energization period.

However, in the case of the motor speed estimation device disclosed in JP2008-295120, there is a possibility for an estimation error of motor speed to undesirably occur. Thus, the reduction of such an error involved in the estimated motor speed data would be desirable.

### SUMMARY OF THE INVENTION

It is, therefore, in view of the previously-described disadvantages of the prior art, an object of the invention to provide a brake control apparatus employing an improved motor speed estimation device configured to ensure high-precision motor speed estimation, while reducing or minimizing estimation errors involved in estimated motor speed data.

In order to accomplish the aforementioned and other objects of the present invention, a brake control apparatus comprises a pump that produces a flow of brake fluid in a hydraulic brake circuit, a motor that drives the pump, and a control unit comprising a motor speed estimation section configured to estimate a revolution speed of the motor based on an inter-terminal voltage of the motor and a motor characteristic of the motor, and a motor speed control section configured to control a speed of the motor based on the motor speed estimated by the motor speed estimation section and a preset target motor speed.

According to another aspect of the invention, a brake control apparatus comprises a pump that discharges and supplies brake fluid drawn from a master cylinder toward individual wheel-brake cylinders, a direct-current brush-equipped motor that drives the pump, and a control unit comprising a motor speed estimation means for estimating a motor speed based on an inter-terminal voltage between terminals of the direct-current brush-equipped motor, an inherent characteristic of the direct-current brush-equipped motor, and a load torque carried on the direct-current brush-equipped motor, and a motor drive control means for controlling an operating mode of the motor based on the motor speed estimated by the motor speed estimation means.

According to a further aspect of the invention, a brake control apparatus comprises a pump that produces a flow of brake fluid in a hydraulic brake circuit, a brush-equipped motor that drives the pump, and a control unit configured to control the brush-equipped motor, the control unit comprising an energization-period motor speed estimation part configured to estimate an energization-period motor speed based on an inter-terminal voltage between terminals of the brush-equipped motor and a motor characteristic of the brush-equipped motor, and a de-energization-period motor speed estimation part configured to estimate a de-energization-period motor speed based on a counter-electromotive force corresponding to the inter-terminal voltage of the brush-equipped motor, wherein the control unit is configured to execute switching between energization and de-energization of the brush-equipped motor responsively to information about the motor speeds estimated by the energization-period motor speed estimation part and the de-energization-period motor speed estimation part.

The other objects and features of this invention will become understood from the following description with reference to the accompanying drawings.

### BRIEF DESCRIPTION OF THE DRAWINGS

FIG. 1 is a system diagram illustrating an automotive brake system to which a motor speed estimation device equipped brake control unit (BCU) of the first embodiment is applied.

FIG. 2 is a hydraulic circuit diagram illustrating a hydraulic circuit of a hydraulic control unit (HCU) constructing part of the brake control unit of the first embodiment.

FIG. 3 is a block/circuit diagram illustrating an electronic control unit (ECU) constructing the remainder of the brake control unit of the first embodiment and including components related to motor drive control.

FIG. 4 is a preprogrammed motor-torque Tm versus motor-speed ω characteristic diagram illustrating the relationship among a motor inter-terminal voltage Vmot, a generated motor torque Tm, and a motor speed ω.

FIG. 5 is a block/circuit diagram illustrating an electronic control unit (ECU) constructing the remainder of the brake control unit of the first embodiment and including an electric-current sensor as well as the components related to motor drive control.

FIG. 6 is a flowchart illustrating a control routine executed within a central processing unit (CPU) incorporated in the ECU of the brake control unit of the first embodiment.

FIGS. 7A-7D are time charts illustrating variations in a motor-drive-demand flag F1, a motor-energization flag F2, a target motor speed ξ, an estimated motor speed ω, and a motor inter-terminal voltage Vmot, all obtained when motor drive control has been executed by the brake control unit of the first embodiment.

FIG. 8 is a flowchart illustrating a control routine executed within a central processing unit (CPU) incorporated in the ECU of the brake control unit of the third embodiment.

FIGS. 9A-9I are time charts illustrating variations in a motor-drive-demand flag F1, a target motor speed ξ, an estimated motor speed ω, a motor-speed deviation ωerr, a derivative dωerr of motor-speed deviation ωerr, an integral iωerr of motor-speed deviation ωerr, a PID controlled variable ζ for motor-speed feedback (F/B) control, a motor-drive duty cycle Duty, a motor current i, and a motor inter-terminal voltage Vmot, all obtained when motor drive control has been executed by the brake control unit of the third embodiment.

### DESCRIPTION OF THE PREFERRED EMBODIMENTS

### First Embodiment

### System Configuration of First Embodiment

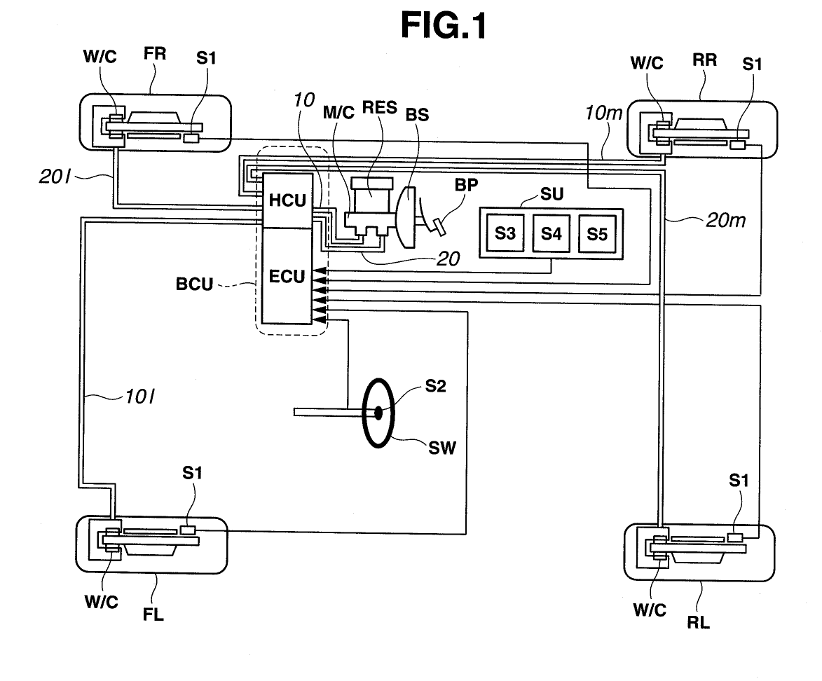

Referring now to the drawings, particularly to FIG. 1, the motor speed estimation device 1 of the first embodiment is exemplified in an automotive brake control unit (BCU). FIG. 1 shows the system diagram of a hydraulic brake system of the BCU-equipped automotive vehicle. The brake system includes a master cylinder M/C, wheel-brake cylinders W/C, the brake control unit BCU connected to the wheel cylinders W/C as well as the master cylinder M/C, and various sensors. A brake pedal BP is connected via a brake booster BS to the master cylinder M/C. Master cylinder M/C receives a brake-fluid supply from a reservoir RES, formed integral with the master cylinder, so as to produce a fluid pressure (i.e., a master-cylinder pressure Pmc) whose pressure value varies depending on an amount of depression of brake pedal BP. Master cylinder M/C is a so-called tandem master cylinder with two pistons, set in tandem. The tandem master cylinder has two separate sections, operating independently and connected via a primary hydraulic-brake circuit 10 and a secondary hydraulic-brake circuit 20, included in respective hydraulic systems, namely, the primary (P) hydraulic system and the secondary (S) hydraulic system, to the brake control unit BCU (exactly, a hydraulic control unit HCU described later). Master cylinder M/C is configured to supply brake fluid through the primary and secondary hydraulic-brake circuits 10 and 20 to respective wheel cylinders W/C, when brake pedal BP is depressed. The four wheel-brake cylinders W/C are provided at respective road wheels FL, FR, RL, and RR, so as to produce brake-fluid pressures (i.e., wheel cylinder pressures Pwc). Wheel cylinders W/C are connected via respective brake-fluid lines 10l, 20l, 20m, and 10m to the brake control unit BCU (exactly, the hydraulic control unit HCU). The various sensors serve as means for detecting a specific condition on the vehicle. For instance, in the shown embodiment, these vehicle sensors are comprised of four wheel speed sensors S1, a steering angle sensor S2, and a vehicle behavior sensor unit SU. Four wheel speed sensors S1 are provided at respective road wheels FL, FR, RL, and RR, for detecting front-left, front-right, rear-left, and rear-right wheel speeds. Steering angle sensor S2 is provided for detecting a rotation angle (that is, a steering angle) of a steering wheel SW, which is operated by the driver. Vehicle behavior sensor unit SU is an integrated sensor unit, which unit is comprised of a yaw rate sensor S3, a longitudinal acceleration sensor S4, and a lateral acceleration sensor S5, for monitoring or detecting a yaw rate, a longitudinal acceleration, and a lateral acceleration, all exerted on the vehicle.

Brake control unit BCU is comprised of an electronic control unit ECU and the hydraulic control unit HCU. In the shown embodiment, these units ECU and HCU are formed integral with each other. In lieu thereof, these units ECU and HCU may be formed as two separate units. As detailed later, electronic control unit ECU receives input information from respective vehicle sensors S1-S5, and also determines, based on input informational data signals from the previously-discussed vehicle sensors, whether brake control intervention or brake control secession is made. In the shown embodiment, the technical term “brake control” means anti-brake skid (ABS) system control (or anti-lock brake system control), vehicle stability control or vehicle dynamics control (VDC), vehicle-to-vehicle distance control or adaptive cruise control (ACC) and the like. In accordance with a demand for each of the above vehicle control functions (ABS, VDC, ACC), a brake-fluid pressure (wheel-cylinder pressure Pwc) of each of road wheels FL-RR is controlled to enhance the safety and convenience of the vehicle. Electronic control unit ECU is configured to operate each of actuators of hydraulic control unit HCU for controlling or regulating wheel-cylinder pressure Pwc of each of the road wheels FL-RR, thereby suitably controlling a vehicle behavior, involving a dynamic behavior of the vehicle. As actuators, hydraulic control unit HCU includes various fluid-pressure control components, more concretely, fluid-pressure control valves 11-15, 17 and 21-25, 27, reservoirs (or hydraulic accumulators) 16 and 26, a pump P, and an electric motor (simply, a motor) M that drives the pump. Hydraulic control unit HCU is configured to appropriately operate these actuators responsively to a control command from the electronic control unit ECU, so as to control wheel-cylinder pressure Pwc of each of the road wheels FL-RR. Concretely, hydraulic control unit HCU is configured to execute fluid—pressure reduction control that wheel-cylinder pressure Pwc is reduced to below the master-cylinder pressure Pmc, for instance, during a pressure-reduction mode of the ABS system control, and also configured to execute fluid-pressure buildup control that wheel-cylinder pressure Pwc is controlled to a pressure value exceeding the master-cylinder pressure Pmc for instance, during vehicle dynamics control or during adaptive cruise control.

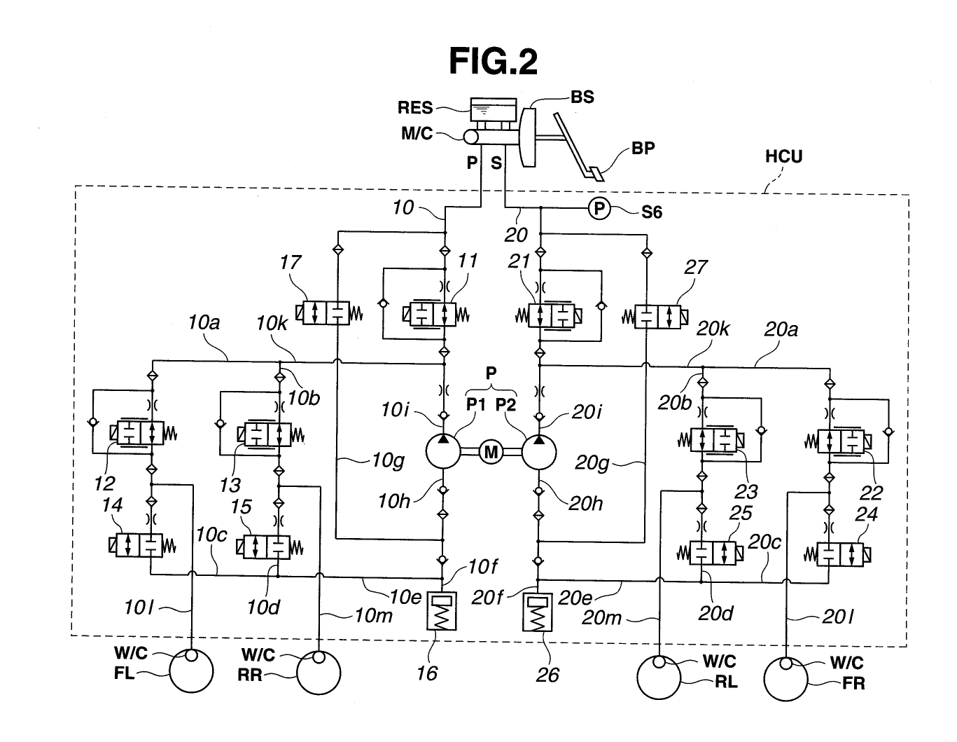

Referring now to FIG. 2, there is shown the hydraulic circuit configuration of hydraulic control unit HCU. As seen from the circuit diagram of FIG. 2, the hydraulic-brake system is split into two sections, that is, the primary (P) hydraulic system and the secondary (S) hydraulic system. In the shown embodiment, the dual hydraulic-brake system is constructed as a so-called diagonal split layout of brake circuits, sometimes termed “X-split layout” that front-left and rear-right wheel-brake cylinders W/C_{(FL)} and W/C_{(RR)} are connected to the brake circuit 10 of the “P” hydraulic system, and that front-right and rear-left wheel-brake cylinders W/C_{(FR)} and W/C_{(RL)} are connected to the brake circuit 20 of the “S” hydraulic system. It will be appreciated that the dual brake system is not limited to such an X-split layout, but that the concept of the invention may be applied to a front-and-rear parallel layout of brake circuits in which the hydraulic brake system is divided into brake circuits respectively associated with front-left and front-right wheel cylinders W/C_{(FL)} and W/C_{(FR)} and rear-left and rear-right wheel cylinders W/C_{(RL)} and W/C_{(RR)}. Pump P and motor M are designed as a hydraulic pump and motor assembly. Actually, the hydraulic pump and motor assembly is divided into two separate pump sections, namely a first pump section (simply a first pump P1) and a second pump section (simply, a second pump P2). Pump P, exactly, the first pump P1 and the second pump P2 are operated by the common motor M, for the purpose of suction and discharge of brake fluid. During rotation of motor M, pump P operates to supply brake fluid drawn from master cylinder M/C to the individual wheel-brake cylinders or to rake out brake fluid stored in reservoirs 16 and 26 incorporated in hydraulic control unit HCU and deliver the brake fluid toward the master cylinder M/C. Motor M is an electric motor that drives the pump P. In the embodiment, this pump motor M is constructed by a direct-current (DC) brush-equipped motor. Each of the fluid-pressure control valves is an electromagnetic valve (a solenoid-operated valve). The fluid-pressure control valves of hydraulic control unit HCU are comprised of shut-off valves (OUT-gate valves) 11, 21, supply valves (IN-gate valves) 17, 27, pressure-hold valves (pressure-buildup valves) 12, 13, 22, 23, and pressure-reduction valves 14, 15, 24, 25. Each of the solenoid valves is configured to produce an axial movement of a solenoid plunger (a valve spool) when an electromagnetic coil of the solenoid valve is energized.

For the sake of simplicity, the brake circuit configuration for only the “P” hydraulic system (i.e., only the brake circuit 10) will be assumed in the following description of the hydraulic brake control system.

Shut-off valve 11 is disposed in a middle of the brake circuit 10, directed from the side of master cylinder M/C to the side of wheel-brake cylinders W/C. A brake line 10k, located on the side of wheel cylinders W/C with respect to the shut-off valve 11, is branched into brake lines 10a and 10b. The brake lines 10a and 10b are connected through brake lines 10l and 10m to respective wheel cylinders W/C_{(FL)} and W/C_{(RR)}. Pressure-hold valves 12 and 13 are disposed in respective brake lines 10a and 10b. Return lines 10c and 10d are connected to brake lines 10a and 10b, located on the side of wheel cylinders W/C with respect to respective pressure-hold valves 12 and 13. Pressure-reduction valves 14 and 15 are disposed in respective return lines 10c and 10d. Return lines 10c-10d are merged together as a return line 10e. The merged return line 10e is connected to the reservoir 16. Reservoir 16 is a built-in reservoir tank incorporated in the hydraulic control unit HCU, for temporarily storing brake fluid. Also, a part of brake circuit 10, located on the side of master cylinder M/C with respect to the shut-off valve 11, is branched to form a suction circuit 10g. Supply valve 17 is disposed in suction circuit 10g for establishing or blocking fluid communication through the suction line 10g. Suction line 10 is merged with a return line 10f, directed from reservoir 16 to the pump, to form a merged suction line 10h. The merged suction line 10h is connected to an inlet port (a suction port) of the first pump P1, serving as a fluid-pressure source that produces a fluid pressure independently of master cylinder M/C. The discharge port of pump P1 is connected through a discharge line 10i to the brake line 10k, located on the side of wheel cylinders W/C with respect to the shut-off valve 11. A check valve is disposed in return line 10f, directed from reservoir 16 to pump P1, to prevent backflow of brake fluid back to reservoir 16. A check valve is disposed in suction line 10h to permit free flow of brake fluid in one direction, that is, toward the inlet port of pump P1. Also, a check valve is disposed in discharge line 10i, to prevent backflow of brake fluid back to the discharge port of pump P1. The brake circuit 20 included in the “S” hydraulic system is also configured in a similar manner to the brake circuit 10 included in the “P” hydraulic system, but a fluid-pressure sensor S6 is attached to the brake circuit 20 on the upstream side (on the master-cylinder side) of suction line 20g of the brake circuit 20, for detecting master-cylinder pressure Pmc.

Each of supply valves 17 and 27 is an ON-OFF valve, concretely, a normally-closed valve, which is normally kept closed in a de-energization state. When regulating or controlling wheel-cylinder pressure Pwc to a pressure level exceeding master-cylinder pressure Pmc, each of supply valves 17 and 27 are energized and thus kept open, so as to enable a brake-fluid supply from master cylinder M/C through pump P to wheel cylinders W/C. Each of shut-off valves 11 and 21 is a proportional-control valve, concretely, a normally-open valve, which is normally kept open in a de-energization state. When regulating or controlling wheel-cylinder pressure Pwc to a pressure level exceeding master-cylinder pressure Pmc, each of shut-off valves 11 and 21 are energized and thus kept closed, so as to prevent brake fluid pressurized by the pump P from returning back to the master cylinder M/C, or so as to arbitrarily control a differential pressure between a fluid pressure of the downstream side (i.e., the wheel-cylinder side) and a fluid pressure of the upstream side (i.e., the master-cylinder side or the pump side) by adjusting a valve opening of each of shut-off valves 11 and 21. An orifice (e.g., a fixed orifice) is disposed in the brake line of the master-cylinder side of each of shut-off valves 11 and 21. Check valves are disposed in parallel with respective shut-off valves 11 and 21, for preventing backflow of brake fluid from the wheel-cylinder side (the pump side) to the master-cylinder side. Each of pressure-hold valves 12, 13, 22, and 23 is a proportional-control valve, concretely, a normally-open valve, which is normally kept open in a de-energization state. When regulating or controlling wheel-cylinder pressure Pwc to a pressure level less than the fluid pressure of the upstream side (e.g., the master-cylinder side), each of pressure-hold valves 12, 13, 22, and 23 is energized and thus kept closed. Furthermore, when a buildup of wheel-cylinder pressure Pwc is required, while utilizing a differential pressure between the upstream side and the downstream side, it is possible to obtain or achieve an arbitrary pressure-buildup gradient of wheel-cylinder pressure Pwc by adjusting a valve opening (or a valve-open period) of each of the pressure-hold valves. An orifice (e.g., a fixed orifice) is disposed in the brake line of the master-cylinder side of each of pressure-hold valves 12, 13, 22, and 23. Check valves are disposed in parallel with respective pressure-hold valves 12, 13, 22, and 23, for preventing backflow of brake fluid from the upstream side (the master-cylinder side) to the downstream side (the wheel-cylinder side). Each of pressure-reduction valves 14, 15, 24, and 25 is an ON-OFF valve, concretely, a normally-closed valve, which is normally kept closed in a de-energization state. When a reduction of wheel-cylinder pressure Pwc is required, for instance, during a pressure-reduction mode of the ABS system control, each of pressure-reduction valves 14, 15, 24, and 25 is energized and thus kept open, so as to permit brake-fluid flow from wheel-brake cylinders W/C to reservoirs 16 and 26. When a reduction of wheel-cylinder pressures Pwc is created with the pressure-reduction valves kept open, each of reservoirs 16 and 26 functions to temporarily store brake fluid, flowing out from the wheel cylinders W/C. An orifice (e.g., a fixed orifice) is disposed in the brake line of the wheel-cylinder side of each of pressure-reduction valves 14, 15, 24, and 25.

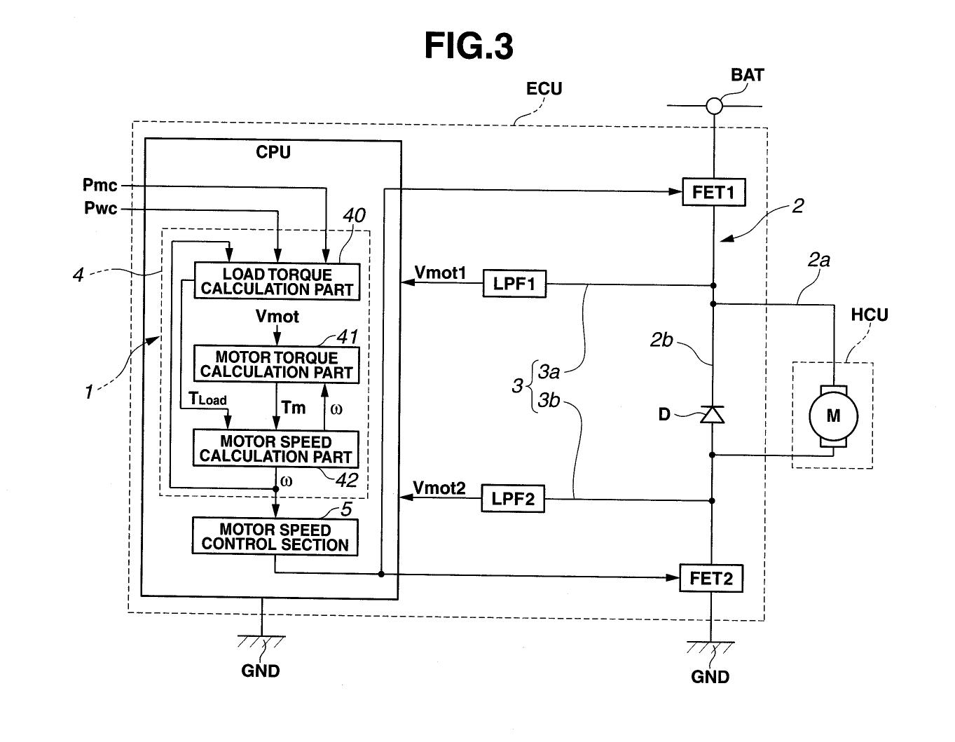

Referring now to FIG. 3, there is shown the block/circuit diagram illustrating the components related to motor drive control executed within electronic control unit ECU. Electronic control unit ECU includes the central processing unit CPU, a drive circuit 2, and a signal circuit 3. The central processing unit of electronic control unit ECU is configured to determine, based on input informational data signals from vehicle sensors S1-S5, whether brake control intervention or brake control secession should be made, and further configured to properly control the operation of hydraulic control unit HCU, depending on whether brake control intervention or brake control secession should be made. When executing brake control based on the result of decision concerning brake control intervention, the CPU estimates a revolution speed ω of motor M, such that the operation of motor M can be controlled on the basis of the estimated motor speed ω.

Drive circuit 2 is an electric-power supply circuit, which is provided to supply a driving electric power from a battery BAT (serving as a power source) to the motor M. Drive circuit 2 includes a power-source circuit 2a, at least one field-effect transistor FET, and a diode D. Power-source circuit 2a is configured to connect the battery BAT to ground GND. Field-effect transistor FET is added to the power-source circuit 2a. Diode D is connected to the power-source circuit 2a in parallel with the motor M. Field-effect transistor FET is a switching device, which is provided for driving the motor M. The FET is configured to operate responsively to a command signal from the CPU, so as to supply a power-source voltage, by which motor M is driven, to the motor. As seen from the block/circuit diagram of FIG. 3, in the first embodiment, as the FET, placed into the power-source circuit 2a, a first field-effect transistor FET1, located on the high-electric-potential side (i.e., on the side of battery BAT with respect to motor M), and a second field-effect transistor FET2, located on the low-electric-potential side (i.e., on the side of ground GND with respect to motor M) are provided. In lieu thereof, either one of the first and second field-effect transistors FET1-FET2 may be provided. Also provided is a bypass circuit 2b connecting the high-potential side of motor M (between the first field-effect transistor FET1 and motor M) and the low-potential side of motor M (between the second field-effect transistor FET2 and motor M). Diode D, serving as a rectifying device, is used in the bypass circuit 2b. When executing ON-OFF control of motor M, diode D operates as a reverse-voltage protection diode. Only on the assumption that a driving cycle (an operating cycle) of motor M is adequately long during execution of ON-OFF control of motor M and thus there is a less risk of an extreme heat buildup of the FET, the diode D may be eliminated.

Signal circuit 3 is a voltage detector, which is provided to detect inter-terminal voltage Vmot of motor M. Signal circuit 3 has a low-pass filter LPF (serving as a filter circuit for noise-elimination/signal-smoothing) that passes signals below a given cut-off frequency and attenuates signals with a frequency above the given cut-off frequency. Signal circuit 3 is constructed by a first signal circuit 3a, connected to the high-potential side of motor M (between the first field-effect transistor FET1 and motor M), and a second signal circuit 3b, connected to the low-potential side of motor M (between the second field-effect transistor FET2 and motor M). As seen from the block/circuit diagram of FIG. 3, in the first embodiment, as low-pass filter LPF, placed into the signal circuit 3, a first low-pass filter LPF1, placed into the first signal circuit 3a, and a second low-pass filter LPF2, placed into the second signal circuit 3b, are provided. A voltage generated on the high-potential side of motor M is taken into the CPU through the first signal circuit 3a via the first low-pass filter LPF1, and then analog-to-digital converted within the CPU, such that the A/D-converted voltage signal is detected as a motor high-potential side voltage Vmot1. In a similar manner, a voltage generated on the low-potential side of motor M is taken into the CPU through the second signal circuit 3b via the second low-pass filter LPF2, and then analog-to-digital converted within the CPU, such that the A/D-converted voltage signal is detected as a motor low-potential side voltage Vmot2.

The CPU includes a motor speed estimation section 4, serving as an estimation means for estimating a revolution speed of motor M (simply, a motor speed), and a motor speed control section (a motor drive control section) 5, serving as a control means for controlling the speed of motor M. Motor speed estimation section 4 constructs an essential operational part of motor speed estimation device 1 of the first embodiment. Motor speed estimation section 4 is configured to estimate a speed of motor M, based on both the motor inter-terminal voltage Vmot and a motor characteristic (for example, a motor-torque versus motor-speed characteristic, as described later). As clearly shown in FIG. 3, motor speed estimation section 4 includes a load torque calculation part 40, a motor generated torque calculation part 41, and a motor speed calculation part 42. Load torque calculation part 40 serves as a calculation means for calculating a load torque carried on the motor M (simply, a motor load torque T_{Load}). Motor generated torque calculation part (simply, a motor torque calculation part) 41 serves as a calculation means for calculating a torque generated by the motor M (simply, a motor torque Tm). Motor speed calculation part 42 is configured to arithmetically calculate and estimate motor speed ω based on both the calculated motor load torque T_{Load} and the motor generated torque (the calculated motor torque) Tm. In the shown embodiment, load torque calculation part 40 is comprised of a fluid-pressure load torque calculation part 401 and a viscosity load torque calculation part 402. Fluid-pressure load torque calculation part 401 is configured to calculate a motor load torque component related to a fluid pressure in the hydraulic control unit HCU, simply, a fluid-pressure-dependent load torque T_{L}. On the other hand, viscosity load torque calculation part 402 is configured to calculate a motor load torque component affected by a speed of motor M (in other words, depending on a viscosity resistance of working fluid, i.e., brake fluid), simply, a viscosity-dependent load torque Tc.

### (Calculation of Fluid-Pressure-Dependent Load Torque T_{L})

Details of arithmetic processing executed within fluid-pressure load torque calculation part 401 are described hereunder. Regarding the primary (P) hydraulic system, a “P”-hydraulic-system fluid-pressure load (simply, a “P”-system motor load pressure) P_{Load}_{_{—}}ₚ and a frictional resistance (a friction-loss torque Tf) of the first pump P1 and motor M of the hydraulic pump and motor assembly function as factors causing the fluid-pressure-dependent load torque T_{L}_{_{—}}ₚ acting on motor M and relating to the “P” system. Regarding the secondary (S) hydraulic system, a “S”-hydraulic-system fluid-pressure load (simply, a “S”-system motor load pressure) P_{Load}_{_{—}}ₛ and a frictional resistance (a friction-loss torque Tf) of the second pump P2 and motor M of the hydraulic pump and motor assembly function as factors causing the fluid-pressure-dependent load torque T_{L}_{_{—}}ₛ acting on motor M and relating to the “S” system. The “P”-system motor load pressure P_{Load}_{_{—}}ₚ and the “S”-system motor load pressure P_{Load}_{_{—}}ₛ, collectively referred to as “motor load pressure P_{Load}”, is obtained as a highest one of master-cylinder pressure Pmc, and wheel-cylinder pressures Pwc (associated with either the “P” system or the “S” system) by way of a -so-called select-HIGH process. Thus, the “P”-system motor load pressure P_{Load}_{_{—}}ₚ and the “S”-system motor load pressure P_{Load}_{_{—}}ₛ, are represented as follows.

“P” system: P_{Load}_{_{—}}ₚ=max (Pmc, PWC_{(FL)}, PWC_{(RR)})

“S” system: P_{Load}_{_{—}}ₛ=max (Pmc, PWC_{(FR)}, Pwc_{(RL)})

As previously discussed, mater-cylinder pressure Pmc is detected by fluid-pressure sensor S6. On the other hand, wheel-cylinder pressure Pwc is estimated based on (i) the estimated motor speed ω, calculated one cycle before (i.e., at the previous execution cycle of brake control), that is, a quantity of brake fluid discharged from pump P, and (ii) a valve-open period of each of the fluid-pressure control valves of hydraulic control unit HCU. Instead of estimating the wheel-cylinder pressure Pwc, four wheel-cylinder pressure sensors may be attached to the respective wheel-brake cylinders, so as to directly detect wheel-cylinder pressures Pwc_{(FL)}, Pwc_{(RR)}, Pwc_{(RL)}, and Pwc_{(FR)}. Assuming that a volumetric efficiency of pump P is denoted by “η”, a cross-sectional area of a plunger of pump P is denoted by “S”, an eccentricity of the rotation axis of motor M is denoted by “e”, the ratio of the circumference of a circle to its diameter (i.e., a circle ratio) is denoted by “n”, a friction-loss torque of the hydraulic pump and motor assembly is denoted by “Tf”, the “P”-system fluid-pressure-dependent load torque T_{L}_{_{—}}ₚ and the “S”-system fluid-pressure-dependent load torque T_{L}_{_{—}}ₛ are represented by the following approximate expressions.

“P” system: T_{L}_{_{—}}ₚ=(η×P_{Load}_{_{—}}ₚ×S×e)/π+Tf

“S” system: T_{L}_{_{—}}ₛ=(η×P_{Load}_{_{—}}ₛ×S×e)/π+Tf

Thus, fluid-pressure-dependent load torque T_{L} is represented as a summed value of the “P”-system fluid-pressure-dependent load torque T_{L}_{_{—}}ₚ and the “S”-system fluid-pressure-dependent load torque T_{L}_{_{—}}ₛ, as follows.

T_{L}=T_{L}_{_{—}}ₚ+T_{L}_{_{—}}ₛ

### (Calculation of Viscosity-Dependent Load Torque Tc)

in the first embodiment, in calculating motor load torque T_{Load}, the load torque component, affected by a speed of motor M (in other words, depending on the viscosity resistance of working fluid), is further considered. For instance, assuming that an estimated motor speed, calculated at the previous execution cycle of brake control, is denoted by “ω” and a viscosity coefficient of working fluid is denoted by “c”, viscosity load torque calculation part 402 calculates viscosity-dependent load torque Tc from the following expression, utilizing the estimated motor speed ω.

Tc=c×ω

Load torque calculation part 40 calculates motor load torque T_{Load}, as a summed value of the calculated fluid-pressure-dependent load torque component T_{L} and the calculated viscosity-dependent load torque component Tc, as follows.

T_{Load}=T_{L}+Tc

### (Calculation of Generated Motor Torque Tm)

Motor torque calculation part 41 is configured to calculate motor torque Tm from the following expression, during a motor de-energization period during which there is no torque produced by motor M.

Tm=0

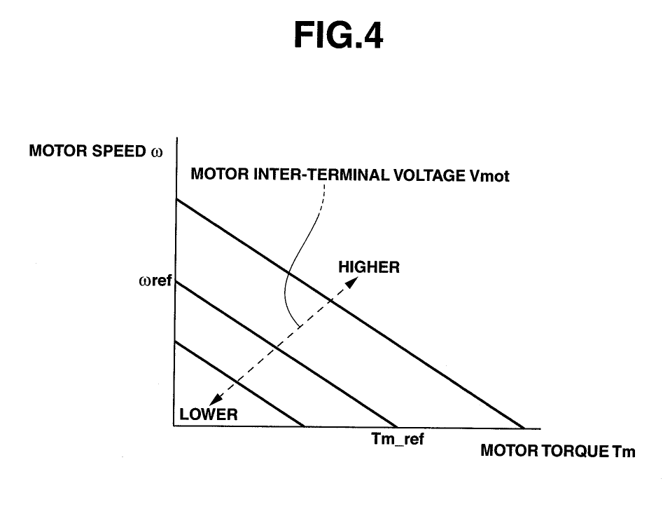

Motor torque calculation part 41 is also configured to calculate motor torque Tm based on the motor inter-terminal voltage Vmot during a motor energization period. The motor inter-terminal voltage Vmot can be calculated as a difference between the detected motor high-potential side voltage Vmot1 and the detected motor low-potential side voltage Vmot2, that is, Vmot=Vmot1−Vmot2. In the first embodiment, the motor low-potential side voltage Vmot2 as well as the motor high-potential side voltage Vmot1 is detected. In lieu thereof, the detection of motor low-potential side voltage Vmot2 may be eliminated, in other words, only the motor high-potential side voltage Vmot1 may detected such that the motor inter-terminal voltage Vmot is determined as the detected motor high-potential side voltage Vmot1, that is, Vmot=Vmot1. Motor torque Tm can be calculated or derived from a motor characteristic (i.e., a motor performance characteristic), more concretely, a motor-torque Tm versus motor-speed ω characteristic diagram as shown in FIG. 4. As appreciated from the motor-torque Tm versus motor-speed ω characteristic diagram of FIG. 4, there is a linear relationship between motor torque Tm versus motor speed ω, every motor inter-terminal voltage Vmot. Depending on the magnitude of motor inter-terminal voltage Vmot, Tm-ω characteristic line tends to translate. Assuming that a motor-voltage reference value is denoted by “Vmot_ref”, a motor-speed reference value ωref under a zero-torque condition (in other words, under a no-load condition) is denoted by “ωref”, and a maximum generated-motor-torque reference value is denoted by “Tm_ref”, the generated motor torque Tm is calculated from the following expression, utilizing the estimated motor speed ω, calculated at the previous execution cycle of brake control.

Tm=Vmot/Vmot_ref×Tm_ref−Tm_ref/ωref×ω

Instead of using the above-mentioned motor-torque calculation method, motor torque Tm may be calculated or derived from the following motor-torque calculation method.

For instance, assuming that an electric current, flowing through motor M, is denoted by “i”, an electric resistance of motor M is denoted by “R”, an inductance of motor M is denoted by “L”, and a counter-electromotive-force constant of motor M is denoted by “Ke”, an equation of electric equilibrium of motor M is represented as follows.

Vmot=R×i+L×di/dt+Ke×ω

The electric current (motor current) “i” is derived from the above-mentioned equation, as follows.

di/dt=1/L(Vmot−R×i−Ke×ω)

i=1/L×∫(Vmot−R×i−Ke×ω)dt

Motor torque Tm is in proportion to motor current i. Assuming that a torque constant of motor M is denoted by “Kt”, motor torque Tm is represented as follows.

Tm=Kt×i=Kt/L×∫(Vmot−R×i−Ke×ω)dt

Also, by eliminating the term concerning the inductance “L” of motor M, the above-mentioned equation of electric equilibrium of motor M may be simply represented as follows.

Vmot=R×i+Ke×ω

i=1/R×(Vmot−Ke×ω)

Tm=Kt×i=Kt/R×(Vmot−Ke×ω)

Instead of using the motor current value “i”, calculated as discussed above, motor current “i” may be detected directly by a current sensor. Motor torque Tm can be derived from the following expression, while utilizing the detected motor current “i”.

Tm=Kt×i

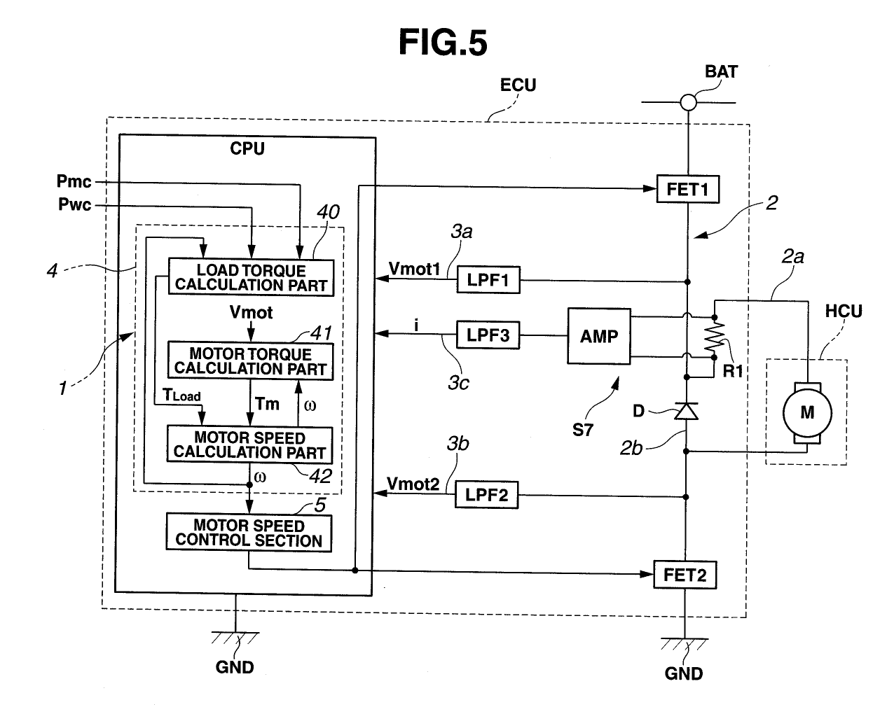

Referring now to FIG. 5, there is shown the modified block/circuit diagram, somewhat modified from the block/circuit diagram of FIG. 3. The modified block/circuit diagram of FIG. 5 further includes a current sensor S7, incorporated in the drive circuit 2. Current sensor S7 is a motor-current detector, which is provided to detect a motor current “i” flowing through the motor M. Current sensor S7 is comprised of a resistor R1, an amplifier AMP, and a signal circuit 3c. Resistor R1 is placed into the power-source circuit 2a on the high-potential side of motor M and arranged near the junction of power-source circuit 2a and bypass circuit 2b. Amplifier AMP is connected to both ends of resistor R1. Signal circuit 3c is connected to amplifier AMP. A low-pass filter LPF3 is placed into the signal circuit 3c. The electric current, flowing through power-source circuit 2a, is amplified by means of amplifier AMP, and then the amplified current is taken into the CPU through the signal circuit 3c via the low-pass filter LPF3, and thereafter analog-to-digital converted within the CPU, such that the A/D-converted current signal is detected as a motor current “i”.

### (Calculation of Motor Speed)

Motor speed calculation part 42 is configured to arithmetically calculate and estimate a speed ω of motor M based on the motor load torque T_{Load} (calculated by load torque calculation part 40), the motor generated torque Tm (calculated by motor torque calculation part 41), and a preset rotational inertia I of motor M. Concretely, assuming that a variation of motor speed per unit time is denoted by “dω”, an equation of equilibrium of torque of motor M is represented as follows.

Tm=I×dω+T_{Load}

The estimated motor speed ω is derived from the above-mentioned equation, as follows.

dω=1/I×(Tm−T_{Load})

ω=∫(dω)dt=1/I×∫(Tm−T_{Load})dt

Motor torque Tm is calculated based on both the motor inter-terminal voltage Vmot and the inherent characteristic of motor M (i.e., the motor's inherent motor-torque versus motor-speed characteristic) during a motor energization period. Thus, motor speed estimation section 4 estimates a speed ω of motor M based on the motor inter-terminal voltage Vmot, the inherent characteristic of motor M (i.e., the motor's inherent motor-torque versus motor-speed characteristic), and the motor load torque T_{Load} carried on the motor M. Also, as previously discussed, motor load torque T_{Load} is calculated based on specifications of the hydraulic pump and motor assembly (pump P and motor M), such as a volumetric efficiency “η” of pump P, a cross-sectional area “S” of the pump plunger, an eccentricity “e” of the rotation axis of motor M, a preset rotational inertia I of motor M, and the like. Hence, motor speed estimation section 4 can estimate a speed ω of motor M based on the motor inter-terminal voltage Vmot, and the inherent characteristic of motor M (more concretely, the motor's inherent motor-torque versus motor-speed characteristic and specifications of the hydraulic pump and motor assembly, such as a volumetric efficiency “η” of pump P, a cross-sectional area “S” of the pump plunger, an eccentricity “e” of the rotation axis of motor M, a preset rotational inertia I of motor M, and the like).

### (Motor Speed Control)

Motor speed control section 5 is configured to control the operation of motor M, responsively to the speed ω of motor M, arithmetically calculated and estimated by motor speed estimation section 4. Concretely, motor speed control section 5 is configured to control the speed of motor M by outputting command signals, determined based on the estimated motor speed ω and a preset target motor speed ξ (described later), to respective field-effect transistors FET1-FET2, and by controlling energization/de-energization of motor M, in such a manner as to bring the estimated motor speed ω closer to the target motor speed ξ. In other words, on the basis of the result of comparison between estimated motor speed ω and target motor speed ξ, switching between energization and de-energization of motor M is controlled by means of motor speed control section 5. In the first embodiment, the estimated motor speed ω is used for a comparatively slow, low-frequency (approximately 100 Hz) motor drive control, that is, ON-OFF control of motor M. More concretely, a first predetermined speed β and a second predetermined speed α are stored in the CPU, and also a first threshold value (i.e., a motor de-energization threshold value (ξ+β)), which is higher than the target motor speed ξ by the first predetermined speed β, and a second threshold value (i.e., a motor energization threshold value (ξ−α)), which is less than the target motor speed ξ by the second predetermined speed α, are both set. Hence, immediately when the estimated motor speed ω exceeds the first threshold value (ξ+β) during the energization of motor M, energization of motor M terminates. Conversely immediately when the estimated motor speed ω becomes less than the second threshold value (ξ−α) during the de-energization of motor M, energization of motor M starts or restarts.

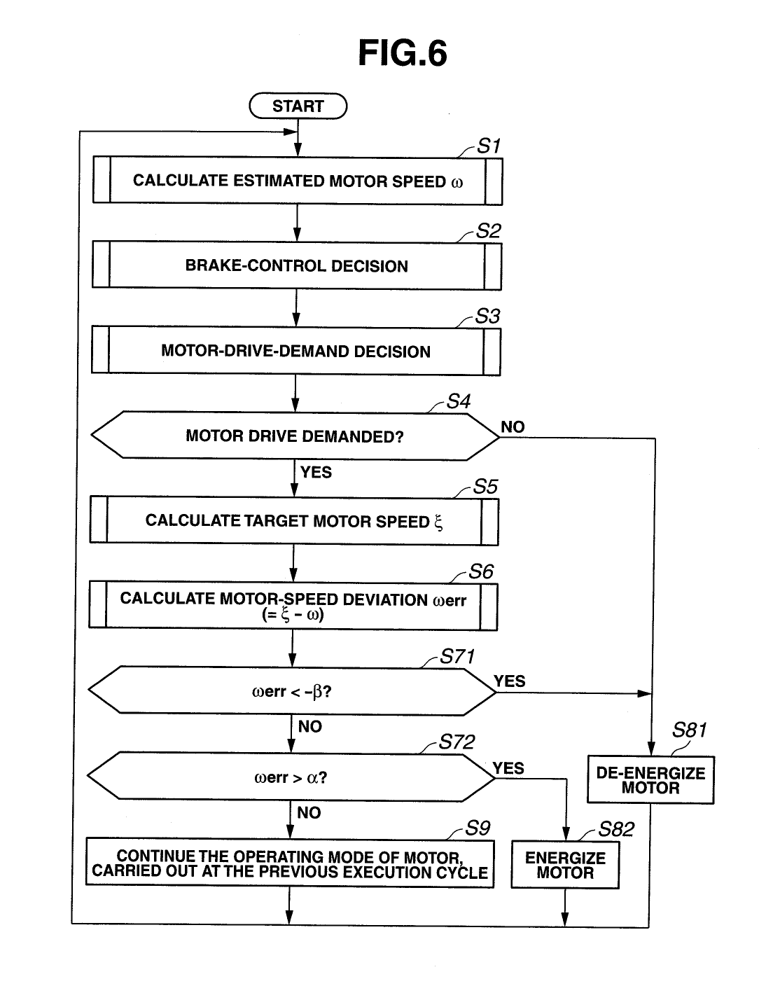

Referring now to FIG. 6, there is shown the control routine executed within the CPU of electronic control unit ECU of the first embodiment. The control routine is executed as time-triggered interrupt routines to be triggered every predetermined sampling time intervals (every predetermined control cycles, concretely, comparatively low-frequency control cycles).

At step S1, motor speed estimation section 4 arithmetically calculates and estimates a speed a of motor M, and then step S2 occurs.

At step S2, a brake-control decision part of the CPU makes a check for the presence or absence of a brake-control demand, such as a demand for either one of vehicle control functions (ABS, VDC, ACC), and then step S3 occurs.

At step S3, a motor-drive-demand decision part of the CPU determines, based on the decision result of the presence or absence of a brake-control demand, whether motor M should be driven. Thereafter, step S4 occurs.

At step S4, a check is made to determine, based on the decision result of step S3, whether a motor-drive demand is present or absent. In the absence of a motor-drive demand, a motor-drive-demand flag F1 and a motor-energization flag F2 are cleared to “0” and then the routine proceeds to step S81. Conversely in the presence of a motor-drive demand, motor-drive-demand flag F1 and motor-energization flag F2 are set to “1”, and then the routine proceeds to step S5.

At step S5, a target motor speed operational part of the CPU calculates a target motor speed ξ of motor M, and then the routine proceeds to step S6. For instance, in the case of anti-brake skid (ABS) system control, target motor speed ξ is preset to a speed value that reservoir 16 (or reservoir 26) does not become full. In the case of vehicle dynamics control, target motor speed ξ is preset to a speed value that can ensure a required pressure-buildup gradient of wheel-cylinder pressure Pwc.

Steps S6, S71-S72, S81-S82, and S9, except steps S1-S5, are executed within motor speed control section 5.

At step S6, a motor-speed deviation ωerr is calculated as a difference (ξ−ω) between target motor speed ξ and estimated motor speed ω, and then the routine proceeds to step S71.

At step S71, a check is made to determine whether the calculated motor-speed deviation ωerr (=ξ−ω) is negative (i.e., ωerr<0) and the absolute value |ωerr| of the calculated motor-speed deviation ωerr exceeds the first predetermined speed β, that is, ωerr<−β. When the answer to step S71 is in the affirmative (YES), that is, ωerr<−β, motor speed control section 5 determines that the estimated motor speed ω exceeds the first threshold value (concretely, the motor de-energization threshold value (ξ+β), that is, ω>(ξ+β). Thus, motor-energization flag F2 is reset to “0” and then the routine proceeds to step S81. Conversely when the answer to step S71 is in the negative (NO), that is, ωerr≧−β, the routine proceeds to step S72.

At step S72, a check is made determine whether the calculated motor-speed deviation ωerr (=ξ−ω) is positive (i.e., ωerr>0) and the calculated motor-speed deviation ωerr exceeds the second predetermined speed α, that is, ωerr>α. When the answer to step S72 is in the affirmative (YES), that is, ωerr>α, motor speed control section 5 determines that the estimated motor speed ω becomes less than the second threshold value (concretely, the motor energization threshold value (ξ−α), that is, ω<(ξ−α). Thus, motor-energization flag F2 is set to “1” and then the routine proceeds to step S82. Conversely when the answer to step S72 is in the negative (NO), that is, ωerr≦α, the routine advances to step S9.

At step S9, the operating mode of motor M, carried out at the previous brake-control execution cycle, that is, either a motor energization state or a motor de-energization state, is continued. This is because the advancement to step S9 means that the estimated motor speed ω does not yet reach the motor de-energization threshold value (ξ+β) in the motor energization state, and also means that the estimated motor speed ω does not yet reach the motor energization threshold value (ξ−α) in the motor de-energization state. After execution of step S9, the routine returns to step S1.

At step S81, motor M is switched to its de-energization state, and then the routine returns to step S1.

At step S82, motor M is switched to its energization state, and then the routine returns to step S1.

### Operation of First Embodiment

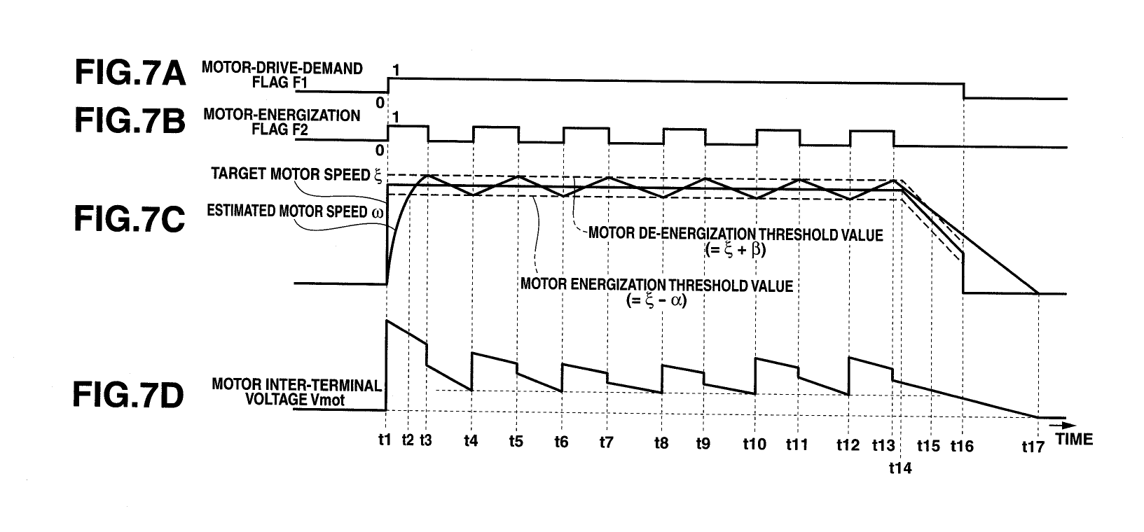

The operation of motor speed estimation device 1 of the first embodiment is hereunder described in detail in reference to the time charts of FIGS. 7A-7D illustrating variations in motor-drive-demand flag F1, motor-energization flag F2, target motor speed estimated motor speed ω, and motor inter-terminal voltage Vmot, all obtained during motor drive control (low-frequency ON-OFF control) executed within the brake control unit (BCU).

Before the time t1, there is no brake-control demand and there is no motor-drive demand, and thus motor-drive-demand flag F1 and motor-energization flag F2 are initialized to “0”. Therefore, just before the time t1, motor M is kept at its de-energization state (see the flow from step S4 to step S81 in FIG. 6), and thus the detected motor inter-terminal voltage Vmot is “0”. At this point of time, target motor speed ξ is not yet calculated and thus the target motor speed value ξ remains set to “0”. On the other hand, estimated motor speed ω is “0”, since motor M is in a stopped state.

Suppose that a brake-control demand for either one of vehicle control functions (ABS, VDC, and ACC) has been made at the time t1. Thus, at the time t1, motor-drive-demand flag F1 is set to “1”, and at the same time target motor speed ξ is calculated (see the flow from step S4 to step S5 in FIG. 6). Assume that the brake-control demand (in other words, motor ON-OFF control demand or motor-drive demand) is continued during the time period (t1-t16) from the time t1 to the time t16, and target motor speed ξ is kept at a fixed value during the time period (t1-t14) from the time t1 to the time t14. At the time t1, estimated motor speed ω(=0) is still less than the motor energization threshold value (ξ−α), that is, ω<(ξ−α), and thus motor-energization flag F2 is set to “1” so as to switch motor M to its energization state (see the flow defined by S6→S71→S72→S82 in FIG. 6). Just after the time t1, the actual speed of motor M begins to rise due to the stepped-up motor inter-terminal voltage Vmot, and thus estimated motor speed ω also begins to rise. However, immediately after the time t1, the motor inter-terminal voltage Vmot tends to gradually drop due to a counter-electromotive force. Immediately before the time t2, estimated motor speed ω still becomes less than the motor energization threshold value (ξ−α), and thus motor-energization flag F2 is continuously kept at “1” so as to continue the motor energization state (see the flow defined by S6→S71→S72→S82 in FIG. 6).

After this, assume that estimated motor speed ω exceeds the motor energization threshold value (ξ−α) at the time t2, and thereafter estimated motor speed ω reaches the motor de-energization threshold value (ξ=β) at the time t3. Thus, during time period (t2-t3), motor-energization flag F2 is continuously kept at “1” so as to continue the operating mode of motor M, carried out at the previous brake-control execution cycle, that is, the motor energization state (see the flow defined by S6→S71→S72→S9 in FIG. 6).

At the time t3, immediately when estimated motor speed ω exceeds the motor de-energization threshold value (ξ+β), motor-energization flag F2 is reset to “0” so as to de-energize the motor M (see the flow defined by S6→S71→S81 in FIG. 6). Immediately after the time t3, owing to switching to de-energization, the actual speed of motor M begins to drop, and thus estimated motor speed ω also begins to drop. As seen in FIG. 7D, immediately when switching from energization to de-energization occurs at the time t3, motor inter-terminal voltage Vmot rapidly drops to an induced voltage developed in the motor M. After the time t3, due to a gradual drop of the actual speed of motor M (i.e., due to a gradual drop of estimated motor speed ω), motor inter-terminal voltage Vmot tends to gradually drop. After this, assume that estimated motor speed ω reaches the motor energization threshold value (ξ−α) at the time t4. Thus, during the time period (t3-t4), estimated motor speed ω is less than or equal to the motor de-energization threshold value (ξ+β) and also greater than or equal to the motor energization threshold value (ξ−α), that is, (ξ−α)≦ω≦(ξ+β), and hence motor-energization flag F2 is continuously kept at “0” so as to continue the operating mode of motor M, carried out at the previous brake-control execution cycle, that is, the motor de-energization state (see the flow defined by S6→S71→S72→S9 in FIG. 6).

At the time t4, immediately when estimated motor speed ω becomes less than the motor energization threshold value (ξ−α), motor-energization flag F2 is set to “1” so as to switch motor M to its energization state (see the flow defined by S6→S71→S72→S82 in FIG. 6). Immediately after the time t4, owing to switching to energization, the actual speed of motor M (in other words, estimated motor speed ω) begins to rise again. Immediately when switching to energization occurs again at the time t4, motor inter-terminal voltage Vmot rapidly rises by an added voltage value corresponding to the amount of supplied electric current.

As can be seen from the time charts of FIGS. 7A-7D (in particular, FIGS. 7C-7D), the tendencies of variations in estimated motor speed ω and motor inter-terminal voltage Vmot obtained during the time period (t4-t5) are similar to those obtained during the time period (t2-t3). Also, the tendencies of variations in estimated motor speed ω and motor inter-terminal voltage Vmot obtained during the time period (t5-t6) are similar to those obtained during the time period (t3-t4). After the time t6, the same tendencies (energization and de-energization states, i.e., on and off states of motor M) are repeated until the time t13 has been reached. In this manner, by virtue of repeated executions of energization/de-energization of motor M, the actual speed of motor M can be appropriately controlled closer to the target motor speed ξ.

At the time t13, motor M has been switched to its de-energization state. Thereafter, from the time t14, the calculated target motor speed ξ begins to gradually decrease. As a matter of course, in accordance with the gradual decrease in target motor speed the motor de-energization threshold value (ξ+β) and the motor energization threshold value (ξ−α) simultaneously begins to decrease from the time t14. Owing to switching of motor M to de-energization at the time t13, the actual speed of motor M (i.e., estimated motor speed ω) tends to gradually drop from the time t13. The gradient of speed decrease in the actual speed of motor M (i.e., estimated motor speed ω) is gentler than that of each of the motor de-energization threshold value (ξ+β) and the motor energization threshold value (ξ−α). Thus, at the time t15, estimated motor speed ω reaches the motor de-energization threshold value (ξ+β). At this time (i.e., at the time t15), according to the flow defined by S6→S71→S81 in FIG. 6, motor-energization flag F2 is continuously kept at “0” so as to continue the motor de-energization state.

At the time t16, a brake-control demand (a motor-drive demand) becomes lost, and thus motor-drive-demand flag F1 is reset to “0”, and also the reset state (F2=0) of motor-energization flag F2 remains unchanged (see the flow defined by S4→S81 in FIG. 6). Thereafter, at the time t17, motor M is shifted to its stopped state. After the time t16, target motor speed ξ is not calculated and thus the target motor speed value ξ is initialized to “0”. On the other hand, after the time t16, motor inter-terminal voltage Vmot and estimated motor speed ω are gradually decreasing. Thereafter, motor inter-terminal voltage Vmot and estimated motor speed ω both become “0” at the time t17.

During the time period for motor drive control (i.e., ON-OFF control of motor M), motor speed estimation device 1 functions to continually estimate a speed of motor M, regardless of whether motor M is in the motor energization state or in the motor de-energization state. Hence, for instance, in a specific situation where the energization state of motor M has to be continued depending on a demand for operation of the hydraulic brake system, it is possible to estimate a speed of motor M without interrupting the energization state of motor M. Thus, it is possible to more appropriately execute brake control by controlling, based on the estimated motor speed ω, the operation of motor M by means of the brake control unit (BCU). By the way, in the shown embodiment, motor speed estimation device 1 is applied to the automotive brake control unit BCU. In lieu thereof, motor speed estimation device 1 may be applied to another electric-motor-operated control system, requiring high-precision motor drive control, except an automotive brake control unit BCU, for example, a pump-motor-operated construction equipment.

(Operation and Effects of Motor Speed Estimation Device of First Embodiment by Comparison with Comparative Example)

In the case of the comparative example as disclosed in JP2008-295120, the motor speed estimation device is configured to estimate a motor speed based on a motor counter-electromotive force (in other words, an induced voltage developed in an inductive circuit of the motor) during a pump-motor de-energization period. In order to enable a motor speed to be estimated under a specific situation where quick braking of the hydraulic brake system is required and hence the motor energization state has to be continued, in the comparative example, a battery voltage, serving as an electric power source, is estimated just before execution of brake control, and then a motor inter-terminal voltage is detected during the motor energization period. A motor speed is estimated based on both the estimated battery voltage and the detected motor inter-terminal voltage. By this, even under the specific situation where high brake-fluid pressure is required during quick braking, brake-fluid circulation control can be executed without interrupting the motor energization state, thereby ensuring the enhanced reliability of the brake system. However, in the motor speed estimation device of the comparative example, there is a possibility for an estimation error of motor speed to undesirably occur owing to fluctuations (variations) in battery voltage during brake control. For instance, in the comparative example, fully taking account of an electric resistance of a power-source wiring harness itself, which harness is connected between the ABS control unit and the battery, as well as an electric resistance of the motor-drive circuit, a battery voltage is estimated based on an inter-terminal voltage of an overall fluid-pressure buildup/reduction control valve system. Therefore, in order to prevent motor speed estimation from being affected by fluctuations in inter-terminal voltage of the overall fluid-pressure buildup/reduction control valve system, caused by switching to energization, the inter-terminal voltage of the overall fluid-pressure buildup/reduction control valve system that is kept de-energized just before brake control, is temporarily stored. A battery voltage is estimated based on the temporarily stored inter-terminal voltage of the overall fluid-pressure buildup/reduction control valve system. For the reasons discussed above, when a variation in battery voltage is occurring during brake control, the estimated battery voltage tends to deviate from an actual battery voltage. Due to such a deviation between the estimated battery voltage and the actual battery voltage, there is a possibility for an estimation error of motor speed to undesirably occur. Additionally, in the comparative example, motor speed estimation is executed, utilizing the arithmetic expression in which an automotive power-source wiring harness resistance and a motor-drive circuit resistance are involved. Such an automotive harness resistance and such a circuit resistance vary between different types of vehicles. Thus, in the case of the comparative example, the arithmetic expression for motor speed estimation has to be properly modified and tuned every adapted car models (every different vehicle types).

In contrast to the above, in the case of motor speed estimation device 1 of the first embodiment, in estimating a speed ω of motor M, configured to drive the pump P that produces a flow of brake fluid in the hydraulic brake circuit, the motor speed is estimated based on the motor inter-terminal voltage Vmot, and the inherent characteristic of motor M (more concretely, the motor's inherent motor-torque versus motor-speed characteristic and specifications of the hydraulic pump and motor assembly, such as a volumetric efficiency “η” of pump P, a cross-sectional area “S” of the pump plunger, an eccentricity “e” of the rotation axis of motor M, a preset rotational inertia I of motor M, and the like). Thus, it is possible to more accurately estimate the motor speed without being affected by electric-power-source voltage variations (battery-voltage variations) occurring during execution of brake control. Hence, it is possible to enhance the accuracy of estimation of motor speed, while more certainly reducing estimation errors involved in the estimated motor speed data, thereby more accurately controlling the rate of discharge of pump P and consequently enhancing the reliability of the hydraulic brake system. Furthermore, in the first embodiment, there is no necessity of tuning the arithmetic expression for motor speed estimation/calculation, even when an automotive harness resistance varies depending on the type of vehicle. This contributes to lower system costs and reduced manufacturing time. In estimating a motor speed, another arithmetic processing, based on a ripple current and/or a ripple voltage between terminals of the motor, can be used or considered. However, in the case that the motor speed is estimated based on readings of ripple current and/or ripple voltage, higher-cycle sampling operation is required such that arithmetic processing has to be executed at shorter sampling time intervals. Additionally, setting of threshold values for ripple current and/or ripple voltage is very difficult. In contrast, in the first embodiment, a speed of motor M can be estimated without using ripple current and/or ripple voltage between terminals of the motor, thus enabling high-precision motor speed estimation with the comparatively simple motor speed estimation system configuration and simple arithmetic calculation method.

In the case of the motor speed estimation device 1 of the first embodiment, motor load torque T_{Load} and motor generated torque (simply, motor torque) Tm are calculated. Then, a speed ω of motor M is calculated (estimated) based on the calculated motor load torque T_{Load}, the calculated motor torque Tm, and a preset rotational inertia I of motor M. In this manner, the motor speed is calculated (estimated), while directly utilizing parameters in the equation of equilibrium of torque of motor M, and thus it is possible to enhance the accuracy of estimation of motor speed. Additionally, the speed ω of motor M is calculated (estimated) based on the motor inter-terminal voltage Vmot, the inherent characteristic of motor M (i.e., the motor's inherent motor-torque versus motor-speed characteristic), and the motor load torque T_{Load} carried on the motor M. In this manner, motor load torque T_{Load} is separated as a different parameter differing from other parameters, and the speed ω of motor M is calculated (estimated), while fully taking into account the motor load torque T_{Load}. Thus, even during brake control that motor load torque T_{Load} is changing successively, it is possible to more accurately estimate the motor speed, without being affected by the successive change in motor load torque T_{Load}, in other words, while sufficiently taking into account the successive change in motor load torque T_{Load} (see the characteristic diagram of FIG. 4). This contributes to the enhanced accuracy of estimation of motor speed. Furthermore, even in the motor de-energization state, it is possible to estimate the motor speed ω by way of the same arithmetic expression as the motor energization state. By the way, in calculating motor load torque T_{Load}, a plurality of load torque components, caused by various factors, can be supposed. In the first embodiment, only two load torque components chosen among the plurality of load torque components are used, thus reconciling and balancing two contradictory requirements, namely, simplified system configuration and enhanced accuracy of estimation of motor speed ω. Actually, in the first embodiment, as the two load torque components, (i) a motor load torque component related to a fluid pressure in the hydraulic control unit HCU, simply, a fluid-pressure-dependent load torque T_{L} and (ii) a motor load torque component affected by a speed of motor M and thus varying depending on a viscosity resistance of working fluid, simply, a viscosity-dependent load torque Tc are calculated. Motor load torque T_{Load} is calculated as the summed value (T_{L}+Tc) of the calculated fluid-pressure-dependent load torque T_{L} and the calculated viscosity-dependent load torque Tc. In this manner, fluid-pressure-dependent load torque T_{L} is separated as a different parameter, and the speed ω of motor M is calculated (estimated), while fully taking into account the fluid-pressure-dependent load torque T_{L}. Thus, even when motor M drives the pump P that produces a flow of brake fluid in the hydraulic brake circuit in accordance with a demand of brake control and thus a fluid-pressure-dependent load on the motor M of the hydraulic pump and motor assembly is fluctuating, it is possible to more accurately estimate the motor speed, without being affected by the fluctuation in fluid-pressure-dependent load imparted on the motor M. As a modification, arithmetic calculation for viscosity-dependent load torque Tc may be eliminated. In the first embodiment, in calculating motor load torque T_{Load}, viscosity-dependent load torque Tc as well as fluid-pressure-dependent load torque T_{L} is sufficiently taken into account. Hence, it is possible to more accurately reflect the influence of the motor load torque on a speed ω of motor M to be estimated (calculated) by further taking the calculation of viscosity-dependent load torque Tc into consideration.

In the shown embodiment, during operation of brake control unit BCU, pump P, incorporated in the hydraulic control unit HCU, operates to discharge and supply brake fluid drawn from master cylinder M/C toward the individual wheel-brake cylinders W/C. Hence, it is advantageous to apply the motor speed estimation device 1 of the first embodiment to this type of brake control that the pump operates to discharge and supply brake fluid drawn from master cylinder M/C toward the individual wheel-brake cylinders W/C. This is because the accuracy of estimation of motor speed ω can be enhanced by means of the motor speed estimation device 1, thus enabling high-precision motor speed control (that is, high-precision control for the rate of discharge of pump P), and consequently enhancing the performance of brake control. During operation of brake control unit BCU, pump P, incorporated in the hydraulic control unit HCU, also operates to deliver brake fluid stored in reservoirs 16 and 26 toward the master cylinder M/C. Hence, even when the brake pedal BP is strongly depressed during operation of the ABS system, it is possible to more certainly return brake fluid stored in reservoirs 16 and 26 back to the master-cylinder side by virtue of high-precision motor speed control (i.e., high-precision pump discharge-rate control), executed by motor speed estimation device 1. In the first embodiment, as a fluid-pressure source that produces a fluid pressure independently of master cylinder M/C, an inexpensive plunger pump P is used. Another type of pump, such as a gear pump may be used. In this case, as a parameter used to calculate fluid-pressure-dependent load torque T_{L}, an appropriate parameter has to be chosen depending on the type of fluid-pressure pump, in place of a pump-plunger cross-sectional area “S”.

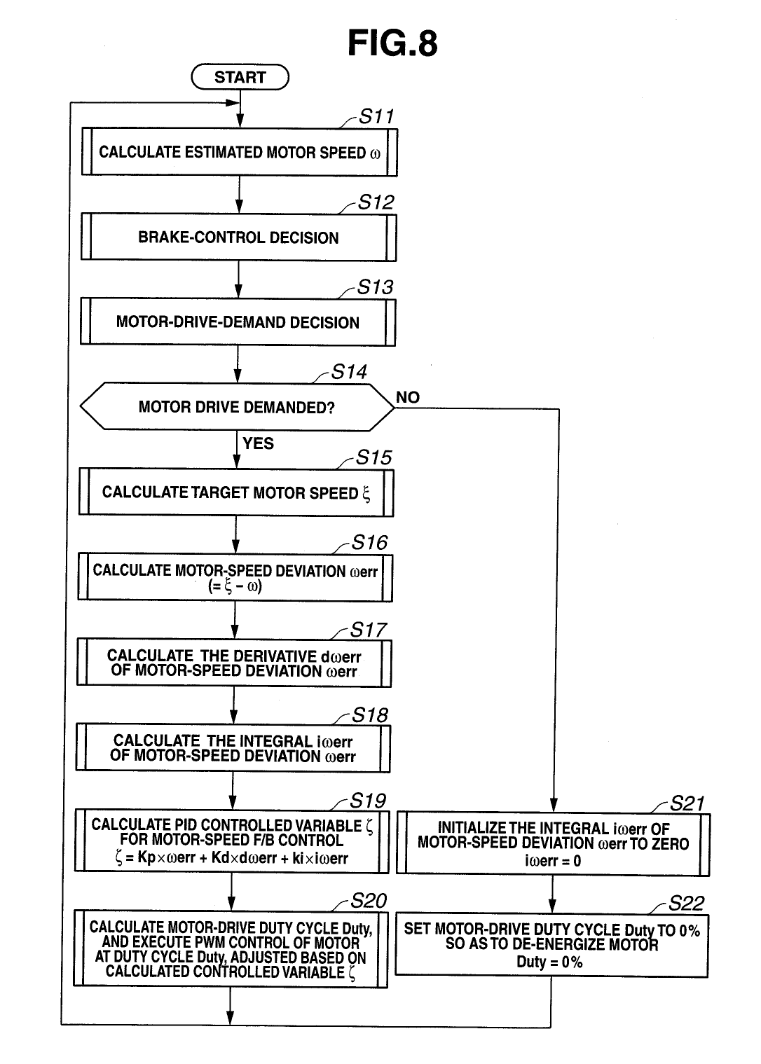

In the first embodiment, as a motor drive control system configuration, an ON-OFF control system is adapted, thus ensuring a more simplified control system configuration. Concretely, during an energization period of motor M, when estimated motor speed ω exceeds the first threshold value (i.e., the motor de-energization threshold value (ξ+β)), which is higher than the target motor speed ξ by the first predetermined speed β, energization of motor M terminates. Conversely, during a de-energization period of motor M, when estimated motor speed ω becomes less than the second threshold value (i.e., the motor energization threshold value (ξ−α)), which is less than the target motor speed ξ by the second predetermined speed α, energization of motor M starts or restarts. In this manner, by virtue of repeated executions of energization/de-energization of motor M, the actual speed of motor M can be appropriately controlled closer to the target motor speed ξ. The first predetermined speed β and the second predetermined speed α may be set to be identical to each other, or these two speeds β and α may be set to be different from each other. In other words, settings of the first threshold value (i.e., the motor de-energization threshold value (ξ+β)) and the second threshold value (i.e., the motor energization threshold value (ξ−α)) are arbitrary. Instead of using ON-OFF control of motor M based on the two threshold values (ξ+β) and (ξ−α), another type of energization/de-energization control of motor M, such as high-frequency PWM (pulse-width modulated) control, may be used (described later in reference to the flowchart of FIG. 8), in a manner so as to bring the actual motor speed closer to the target motor speed ξ.

### Effects of First Embodiment

The motor speed estimation device equipped brake control apparatus of the first embodiment provides the following effects (1)-(6).

(1) The brake control apparatus includes a pump P that produces a flow of brake fluid in a hydraulic brake circuit 10, 20, a motor M that drives the pump P, and a control unit (CPU). The control unit (CPU) includes a motor speed estimation section 4 configured to estimate a revolution speed ω of the motor M based on an inter-terminal voltage Vmot of the motor M and a motor characteristic of the motor M, and a motor speed control section 5 configured to control a speed of the motor M based on the motor speed ω estimated by the motor speed estimation section 4 and a preset target motor speed ξ.

Hence, even during the motor energization period, it is possible to enhance the accuracy of estimation of speed of motor M, thereby enhancing the performance of brake control. That is, it is possible to reduce estimation errors involved in the estimated motor speed data.

(2) The brake control apparatus further includes a load torque calculation part 40 configured to calculate a load torque T_{Load} carried on the motor M, and a motor torque calculation part 41 configured to calculate a motor torque Tm generated by the motor M. The motor speed estimation section 4 estimates the motor speed ω based on the calculated load torque T_{Load}, the calculated motor torque Tm, and a preset rotational inertia I of the motor M.

Thus, it is possible to enhance the accuracy of estimation of motor speed by estimating the motor speed ω, while directly utilizing parameters in the equation of equilibrium of torque of the motor M.

(3) The load torque calculation part 40 includes a fluid-pressure load torque calculation part 401 configured to calculate a motor load torque component T_{L} related to a fluid pressure and a viscosity load torque calculation part 402 configured to calculate a motor load torque component Tc affected by the speed of the motor M and depending on a viscosity resistance of working fluid. The load torque T_{Load} is calculated as a summed value (T_{L}+Tc) of the calculated motor load torque component T_{L} and the calculated motor load torque component Tc.

Thus, even when a fluid-pressure-dependent load on the motor M of the hydraulic pump and motor assembly is fluctuating during execution of brake control, it is possible to more accurately estimate the motor speed ω, without being affected by the fluctuation in fluid-pressure-dependent load imparted on the motor M.

(4) The brake control apparatus includes a pump P that discharges and supplies brake fluid drawn from a master cylinder M/C toward individual wheel-brake cylinders W/C, a direct-current brush-equipped motor M that drives the pump P, and a control unit (CPU). The control unit includes a motor speed estimation means (a motor speed estimation section 4) for estimating a motor speed ω based on an inter-terminal voltage Vmot between terminals of the direct-current brush-equipped motor M, an inherent characteristic of the direct-current brush-equipped motor M, and a load torque T_{Load} carried on the direct-current brush-equipped motor M, and a motor drive control means (a motor speed control section 5) for controlling the operation (an operating mode) of the motor M based on the motor speed ω estimated by the motor speed estimation means.

Hence, the above-mentioned apparatus can provide the same effect as the item (1) of the first embodiment. Additionally, even during brake control that the motor load torque T_{Load} is changing successively, it is possible to more accurately estimate the motor speed, without being affected by the successive change in motor load torque T_{Load}.

(5) The motor drive control means (the motor speed control section 5) is configured to control the operation (the operating mode) of the motor M based on a preset target motor speed ξ. In this manner, by reducing estimation errors involved in the estimated motor speed data, while executing motor speed control, it is possible to enhance the accuracy of motor-drive control, in other words, the performance of brake control. The motor drive control means (the motor speed control section 5) is further configured to follow or bring the motor speed ω estimated by the motor speed estimation section 4 closer to the target motor speed ξ.

As discussed above, the estimated motor speed ω is used for motor drive control (motor speed control), and hence it is possible to enhance the accuracy of motor drive control.

(6) The control unit CPU is configured to have a first threshold value (i.e., a motor de-energization threshold value (ξ+β)), which is higher than the target motor speed by a first predetermined speed β, and a second threshold value (i.e., a motor energization threshold value (ξ−α)), which is less than the target motor speed ξ by a second predetermined speed α. The control unit CPU is further configured to terminate energization of the motor M when the motor speed ω estimated by the motor speed estimation section 4 exceeds the first threshold value (ξ+β) during an energization period of the motor M, and also configured to start energization of the motor M when the motor speed ω estimated by the motor speed estimation section 4 becomes less than the second threshold value (ξ−α) during a de-energization period of the motor M.

As discussed above, with the simplified control system configuration, ON-OFF control of the motor can be realized in a manner so as to bring the estimated motor speed ω closer to the target motor speed ξ. Hence, the above-mentioned apparatus can provide the same effect as the item (5) of the first embodiment.

### Second Embodiment

The motor speed estimation device 1 of the second embodiment is configured to change a method for estimating a speed of motor M, depending on whether motor M is in an energization state or in a de-energization state. The method of the second embodiment for estimating a speed of motor M during the energization period is similar to the first embodiment. The second embodiment differs from the first embodiment, in that the motor speed estimation device of the second embodiment is configured to estimate the motor speed, using a counter-electromotive force (in other words, an induced voltage developed in an inductive circuit of the motor) during the de-energization period. For the purpose of simplification of the disclosure, only the difference point of the second embodiment, differing from the first embodiment, is hereunder described in detail.

The motor speed estimation section 4 of the second embodiment includes (i) an energization-period motor speed estimation part 4a serving as estimation means for estimating a motor speed during an energization period and (ii) a de-energization-period motor speed estimation part 4b serving as estimation means for estimating a motor speed during a de-energization period. The energization-period motor speed estimation part 4a is configured to calculate a value obtained by adding a variation dω of motor speed per unit time, estimated at the current execution cycle (that is, an integration value ∫(dω)dt of a variation dω of motor speed per unit time, estimated every energization-period control cycle), to a motor speed ω0 estimated immediately before energization (concretely, at a control cycle executed immediately before switching from de-energization to energization) as estimated motor speed ω. In the same manner as arithmetic processing executed within the device of the first embodiment, in the second embodiment, the variation dω of motor speed per unit time is represented as follows.

dω=1/I×(Tm−T_{Load})

Thus, the energization-period motor speed is calculated by the following expression.

ω=ω0+∫(dω)dt=ω0+1/I×∫(Tm−T_{Load})dt

On the other hand, the de-energization-period motor speed is in proportion to a counter-electromotive force, observed from the de-energization-period motor inter-terminal voltage Vmot. Thus, assuming that a counter-electromotive-force constant of motor M is denoted by “Ke”, the de-energization-period motor speed is represented as follows.

ω=Vmot/Ke

Hence, the de-energization-period motor speed estimation part 4b is configured to arithmetically calculate and estimate a motor speed ω, utilizing the above-mentioned expression ω=Vmot/Ke. For motor drive control (i.e., ON-OFF control of motor M), the CPU of electronic control unit ECU executes appropriate switching between energization and de-energization of motor M responsively to information about the motor speeds ω estimated by energization-period motor speed estimation part 4a and de-energization-period motor speed estimation part 4b.

As discussed above, during the de-energization period of motor M, the motor speed estimation device 1 of the second embodiment estimates a de-energization-period motor speed based on the counter-electromotive force corresponding to the de-energization-period inter-terminal voltage Vmot of motor M. Hence, it is possible to reduce operation load of the CPU by virtue of a simplified estimation rule of the de-energization-period motor speed. On the other hand, during the energization period, the motor speed estimation device 1 of the second embodiment estimates a de-energization-period motor speed as a value (ω0+∫(dω)dt), obtained by adding a variation dω of motor speed per unit time, estimated at the current execution cycle, to a motor speed ω0 estimated immediately before energization, in a similar manner to the first embodiment. In this manner, on the one hand, the motor speed estimation device 1 of the second embodiment can estimate the de-energization-period motor speed by a comparatively simple estimation method (see the simple arithmetic expression ω=Vmot/Ke) as discussed above. On the other hand, the motor speed estimation device 1 of the second embodiment can more accurately estimate the energization-period motor speed by the estimation method (i.e., the arithmetic expression) similar to the first embodiment. Thus, the second embodiment can provide the same effects as the first embodiment.

### Effects of Second Embodiment

(1) The control unit (CPU) has a de-energization-period motor speed estimation part 4b configured to estimate a de-energization-period motor speed based on a counter-electromotive force corresponding to a de-energization-period inter-terminal voltage Vmot of the motor M. Hence, it is possible to reduce operation load of the CPU by virtue of a simplified estimation rule of the de-energization-period motor speed.

(2) The motor speed estimation section 4 is further configured to set, during an energization period of the motor M, a value (ω0+∫(dω)dt) obtained by adding a variation dω of motor speed per unit time, estimated at a current execution cycle, to a motor speed ω0, estimated immediately before switching to energization of the motor M, as the estimated motor speed ω. Hence, the above-mentioned apparatus can provide the effects as recited in the items (1)-(6) of the first embodiment, as well as the effect as recited in the item (1) of the second embodiment. That is, it is possible to reduce estimation errors involved in the estimated motor speed data, while reducing operation load of the CPU.

(3) The brake control apparatus includes a pump P that produces a flow of brake fluid in a hydraulic brake circuit 10, 20, a brush-equipped motor M that drives the pump P, and a control unit (CPU) configured to control the brush-equipped motor M. The control unit (CPU) includes (i) an energization-period motor speed estimation part 4a configured to estimate an energization-period motor speed based on an inter-terminal voltage Vmot between terminals of the brush-equipped motor M and a motor characteristic of the brush-equipped motor M, and (ii) a de-energization-period motor speed estimation part 4b configured to estimate a de-energization-period motor speed based on a counter-electromotive force corresponding to the inter-terminal voltage Vmot of the brush-equipped motor M. The control unit (CPU) is configured to execute switching between energization and de-energization of the brush-equipped motor M responsively to information about the motor speeds ω estimated by the energization-period motor speed estimation part 4a and the de-energization-period motor speed estimation part 4b.

As discussed above, according to the second embodiment, a method for estimating a motor speed can be varied depending on whether motor M is in an energization state or in a de-energization state. Hence, the above-mentioned apparatus can provide the effects as recited in the items (1)-(6) of the first embodiment, as well as the effect as recited in the item (1) of the second embodiment.

### Third Embodiment

In the motor speed estimation device 1 of the third embodiment, the estimated motor speed ω is used for a comparatively fast, high-frequency (approximately 1 kHz or more) motor drive control, that is, PWM (pulse-width modulated) control of motor M. For the purpose of simplification of the disclosure, only the difference point of the third embodiment, differing from the first embodiment, is hereunder described in detail.

In the third embodiment, when motor M is driven by high-frequency PWM control, diode D, included in the drive circuit 2 shown in FIG. 3, operates as a flywheel diode, often called a freewheeling diode. A cycle of PWM control (that is, a motor-drive control cycle) is set to a comparatively shorter time interval (in other words, a comparatively high-frequency cycle), so as to provide a flywheel effect. Motor speed control section 5 includes a motor-speed deviation calculation part 50, serving as calculation means for a difference (ξ−ω) between target motor speed ξ and estimated motor speed ω, that is, a motor-speed deviation ωerr (=ξ−ω). Motor speed control section 5 is configured to adjust a duty cycle value of a pulse-width modulated signal needed for driving motor M (simply, a motor-drive duty cycle Duty) responsively to the calculated motor-speed deviation ωerr. Concretely, motor speed control section 5 is configured to calculate, based on the calculated motor-speed deviation ωerr (=ξ−ω), a feedback (F/B) controlled variable, such as a PID controlled variable ζ, and further configured to determine, based on the calculated F/B controlled variable (PID controlled variable ζ), the motor-drive duty cycle Duty, and further configured to control pulse-width modulation of energization of motor M at the adjusted motor-drive duty cycle Duty.

Referring now to FIG. 8, there is shown the control routine executed within the CPU of electronic control unit ECU of the third embodiment. The control routine is also executed as time-triggered interrupt routines to be triggered every predetermined sampling time intervals (every predetermined control cycles, concretely, comparatively high-frequency control cycles). Steps S11-S13 and S15-S16 of the flowchart of the third embodiment shown in FIG. 8 are respectively equal to steps S1-S3 and S5-S6 of the first embodiment shown in FIG. 6. Thus, steps S14, and S17-S22 will be hereinafter described in detail, while detailed description of steps S11-S13 and S15-S16 (respectively equal to steps S1-S3 and S5-S6) will be omitted because the above description thereon seems to be self-explanatory.

At step S14, a check is made to determine, based on the decision result of step S13, whether a motor-drive demand is present or absent. In the absence of a motor-drive demand, a motor-drive-demand flag F1 is cleared to “0” and then the routine proceeds to step S21. Conversely in the presence of a motor-drive demand, motor-drive-demand flag F1 is set to “1”, and then the routine proceeds to step S15. Steps S15-S16 of the third embodiment are equal to steps S5-S6 of the first embodiment. Subsequently to steps S15-16, step S17 occurs.

At step S17, a gradient of change in motor-speed deviation ωerr, calculated through step S16, that is, a derivative dωerr of the calculated motor-speed deviation ωerr, is calculated as follows. Thereafter, the routine proceeds to step S18.

dωerr=ωerr_{(new)}−ωerr_{(old)}

where ωerr_{(new)} denotes a motor-speed deviation sampled at the current control cycle, and ωerr_{(old)} denotes a motor-speed deviation sampled at the previous control cycle (i.e., one execution cycle before).

By the way, in order to suppress the calculated data (i.e., the derivative dωerr) from being affected by noise, older motor-speed deviation data, sampled two or more execution cycles before, may be used as the previously-sampled motor-speed deviation ωerr_{(old)}. Alternatively, to eliminate noise, involved in the calculated data concerning the derivative dωerr, a low-pass filter may be applied to the derivative dωerr.

At step S18, the integral iωerr of the calculated motor-speed deviation ωerr is calculated as follows. Thereafter, the routine proceeds to step S19.

iωerr=∫ωerrdt

At step S19, a feedback (F/B) controlled variable for motor-speed feedback control, that is, a PID controlled variable ζ, is calculated as a linear combination of the calculated motor-speed deviation ωerr, its derivative dωerr, and its integral iωerr, from the following expression.

ζ=Kp×ωerr+Kd×dωerr+Ki×iωerr

where the above-mentioned three terms Kp, Kd, and Ki denote respective adjustable gains for a proportional term, a differentiating term, and an integrating term of PID control.

At step S20, motor-drive duty cycle Duty is calculated as follows, so as to control pulse-width modulation of energization of motor M at the calculated motor-drive duty cycle Duty.

Duty=Kduty×ζ

where Kduty denotes a conversion factor needed for converting the calculated PID controlled variable ζ into motor-drive duty cycle Duty.

Through steps S21-S22, the operating mode of motor M is switched to de-energization. Concretely, at step S21, the integral iωerr of motor-speed deviation ωerr is reset or initialized to “0”. Then, at step S22, motor-drive duty cycle Duty is set to the lowest duty-cycle value such as 0%. Thereafter, the routine returns to step S11.

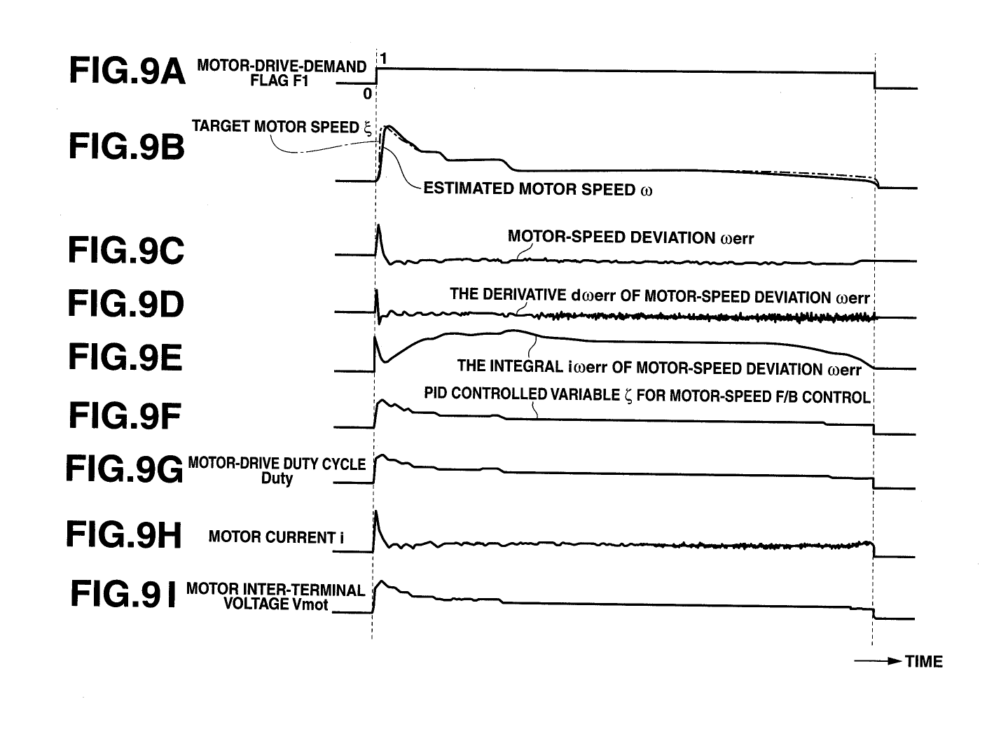

Referring now to FIGS. 9A-9I, there is shown the time charts illustrating variations in motor-drive-demand flag F1, target motor speed ξ, estimated motor speed ω, motor-speed deviation ωerr, the derivative dωerr of motor-speed deviation ωerr, the integral iωerr of motor-speed deviation ωerr, PID controlled variable ζ for motor-speed F/B control, motor-drive duty cycle Duty, motor current i, and motor inter-terminal voltage Vmot, all obtained during PWM control of motor M executed within the brake control unit (BCU) of the third embodiment. As can be seen from the high-frequency PWM control characteristics shown in FIGS. 9A-9I, the actual speed of motor M (i.e., estimated motor speed ω) can be controlled in such a manner as to be more smoothly vary, as compared to estimated-motor-speed-ω-variation characteristic of FIG. 7C, obtained by low-frequency ON-OFF control executed within the brake control unit (BCU) of the first embodiment. Thus, the device of the third embodiment, which is configured to execute high-frequency PWM control, is superior to that of the first embodiment, which is configured to execute low-frequency ON-OFF control, in reduced noise and vibrations.

### Effects of Third Embodiment

The motor speed estimation device equipped brake control apparatus of the third embodiment provides the following effects (1)-(2).

(1) The control unit (CPU) includes a motor-speed deviation calculation part 50 configured to calculate a motor-speed deviation ωerr (=ξ−ω) between the preset target motor speed ξ and the estimated motor speed ω. The control unit (CPU) is configured to adjust a duty cycle Duty of a pulse-width modulated signal needed for driving the motor M responsively to the calculated motor-speed deviation ωerr. Thus, it is possible to effectively reduce noise and vibrations during operation of motor M, while reducing estimation errors involved in the estimated motor speed data.

(2) The motor-speed estimation rule of the second embodiment, configured to enable both (i) high-precision energization-period motor speed estimation and (ii) simplified de-energization-period motor speed estimation, may be applied to the brake control unit (BCU) of the third embodiment. In this case, the control unit (CPU) includes a motor-speed deviation calculation part 50 configured to calculate an energization-period motor-speed deviation ωerr as a difference between the preset target motor speed ξ and the estimated energization-period motor speed ω during the motor energization period, and also configured to calculate a de-energization-period motor-speed deviation ωerr as a difference between the preset target motor speed ξ and the estimated de-energization-period motor speed ω during the motor de-energization period. The control unit (CPU) is configured to adjust a duty cycle Duty of a pulse-width modulated signal needed for driving the motor M responsively to information about the calculated energization-period motor-speed deviation ωerr and the calculated de-energization-period motor-speed deviation ωerr. Hence, the above-mentioned apparatus can provide the effects as recited in the items (1)-(3) of the second embodiment, as well as the effect as recited in the item (1) of the third embodiment.

### Fourth Embodiment

In estimating a revolution speed of motor M, motor speed estimation device 1 of the fourth embodiment uses a detected value of motor current “i”. For the purpose of simplification of the disclosure, only the difference point of the fourth embodiment, differing from the first embodiment, is hereunder described in detail. Current sensor S7, incorporated in the drive circuit 2 (see the block/circuit diagram of FIG. 5) can be used as a motor current sensor. By the use of the detected motor current “i” within motor speed estimation section 4 of the fourth embodiment, estimated motor speed ω is derived from an equation of electric equilibrium of motor M, as follows.

Vmot=R×i+L×di/dt+Ke×ω

ω=1/Ke×(Vmot−R×i−L×di/dt)

Also, by eliminating the term concerning the inductance “L” of motor M, estimated motor speed ω may be derived from the equation of electric equilibrium of motor M, as follows.

Vmot=R×i+Ke×ω

ω=1/Ke×(Vmot−R×i)

The estimated motor speed ω, derived by the brake control unit (BCU) of the fourth embodiment, can be used for ON-OFF control of motor M related to the first embodiment or used for PWM control of motor M related to the third embodiment.

### Effects of Fourth Embodiment

Motor speed estimation section 4 is configured to estimate a motor speed ω based on the detected motor current “i”, the inter-terminal voltage Vmot of motor M, and the inherent characteristic of motor M (more concretely, an electric resistance R of motor M, an inductance L of motor M, a counter-electromotive-force constant Ke of motor M, and the like). Hence, the above-mentioned apparatus can provide the same effects as the items (1)-(6) of the first embodiment.

### Modifications

It will be appreciated that the invention is not limited to the particular embodiments (the first to fourth embodiments) shown and described herein, but that various changes and modifications may be made without departing from the scope or spirit of this invention. For instance, regarding motor-drive control, ON-OFF control, as achieved by the motor speed control system of the first embodiment, may be combined with PWM control, as achieved by the motor speed control system of the third embodiment. More concretely, when estimated motor speed ω exceeds the first threshold value (i.e., a motor de-energization threshold value (ξ+β)) during a motor energization period (that is, during execution of PWM control of motor M at a duty cycle Duty adjusted, based on motor-speed deviation ωerr, to a duty cycle value greater than the lowest duty-cycle value such as 0%), energization of motor M (that is, PWM control executed at the adjusted duty cycle Duty greater than 0%) is terminated so as to re-adjust the duty cycle Duty to 0%. Conversely when estimated motor speed ω becomes less than the second threshold value (i.e., a motor energization threshold value (ξ−α)) during a motor de-energization period (that is, with motor M de-energized by a pulse-width modulated signal at the duty cycle Duty reset to 0%), energization of motor M (that is, PWM control of motor M at a duty cycle Duty adjusted, based on motor-speed deviation ωerr, to a duty cycle value of 0%) is initiated. In the case of the previously-noted modification (PWM control combined with ON-OFF control), it is possible to more effectively reduce noise and vibrations during operation of motor M, while effectively suppressing excessive overshoot of the actual speed of motor M (i.e., estimated motor speed ω) with respect to target motor speed ξ and thus rapidly converging the actual motor speed closer to the target motor speed ξ.

The entire contents of Japanese Patent Application No. 2010-251752 (filed Nov. 10, 2010) are incorporated herein by reference.

While the foregoing is a description of the preferred embodiments carried out the invention, it will be understood that the invention is not limited to the particular embodiments shown and described herein, but that various changes and modifications may be made without departing from the scope or spirit of this invention as defined by the following claims.

What is claimed is:

1. A brake control apparatus comprising:
a pump that produces a flow of brake fluid in a hydraulic brake circuit;
a motor that drives the pump; and
a control unit comprising:
a motor speed estimation section configured to estimate a revolution speed of the motor based on an inter-terminal voltage of the motor and a motor characteristic of the motor; and
a motor speed control section configured to control a speed of the motor based on the motor speed estimated by the motor speed estimation section and a preset target motor speed.

2. The brake control apparatus as claimed in claim 1, wherein:
the control unit is configured to have a first threshold value, which is higher than the target motor speed by a first predetermined speed, and a second threshold value, which is less than the target motor speed by a second predetermined speed; and
the control unit is further configured to terminate energization of the motor when the motor speed estimated by the motor speed estimation section exceeds the first threshold value during an energization period of the motor, and also configured to start energization of the motor when the motor speed estimated by the motor speed estimation section becomes less than the second threshold value during a de-energization period of the motor.

3. The brake control apparatus as claimed in claim 2, wherein:
the control unit has a de-energization-period motor speed estimation part configured to estimate a de-energization-period motor speed based on a counter-electromotive force corresponding to a de-energization-period inter-terminal voltage of the motor.

4. The brake control apparatus as claimed in claim 1, wherein:
the motor speed control section is further configured to bring the motor speed estimated by the motor speed estimation section closer to the target motor speed.

5. The brake control apparatus as claimed in claim 1, further comprising:
a load torque calculation part configured to calculate a load torque carried on the motor; and
a motor torque calculation part configured to calculate a motor torque generated by the motor,
wherein the motor speed estimation section estimates the motor speed based on the calculated load torque, the calculated motor torque, and a preset rotational inertia of the motor.

6. The brake control apparatus as claimed in claim 5, wherein:
the load torque calculation part comprises:
a fluid-pressure load torque calculation part configured to calculate a motor load torque component related to a fluid pressure; and
a viscosity load torque calculation part configured to calculate a motor load torque component affected by the speed of the motor and depending on a viscosity resistance of working fluid; and
the load torque is calculated as a summed value of the calculated motor load torque component and the calculated motor load torque component.

7. The brake control apparatus as claimed in claim 5, wherein:
the motor speed estimation section is further configured to set, during an energization period of the motor, a value obtained by adding a variation of motor speed per unit time, estimated at a current execution cycle, to a motor speed, estimated immediately before switching to energization of the motor, as the estimated motor speed.

8. The brake control apparatus as claimed in claim 1, wherein:
the control unit comprises:
a motor-speed deviation calculation part configured to calculate a motor-speed deviation between the preset target motor speed and the estimated motor speed; and
the control unit is configured to adjust a duty cycle of a pulse-width modulated signal needed for driving the motor responsively to the calculated motor-speed deviation.

9. A brake control apparatus comprising:
a pump (P) that discharges and supplies brake fluid drawn from a master cylinder toward individual wheel-brake cylinders;
a direct-current brush-equipped motor that drives the pump; and
a control unit comprising:
a motor speed estimation means for estimating a motor speed based on an inter-terminal voltage between terminals of the direct-current brush-equipped motor, an inherent characteristic of the direct-current brush-equipped motor, and a load torque carried on the direct-current brush-equipped motor; and
a motor drive control means for controlling an operating mode of the motor based on the motor speed estimated by the motor speed estimation means.

10. The brake control apparatus as claimed in claim 9, wherein:
the motor drive control means is configured to control the operating mode of the motor based on a preset target motor speed.

11. The brake control apparatus as claimed in claim 10, further comprising:
a load torque calculation means for calculating a load torque carried on the motor; and
a motor torque calculation means for calculating a motor torque generated by the motor,
wherein the motor speed estimation means estimates the motor speed based on the calculated load torque, the calculated motor torque, and a preset rotational inertia of the motor.

12. The brake control apparatus as claimed in claim 11, wherein:
the load torque calculation means comprises:
a fluid-pressure load torque calculation means for calculating a motor load torque component related to a fluid pressure; and
a viscosity load torque calculation means for calculating a motor load torque component affected by the speed of the motor and depending on a viscosity resistance of working fluid; and
the load torque is calculated as a summed value of the calculated motor load torque component and the calculated motor load torque component.

13. The brake control apparatus as claimed in claim 12, wherein:
the motor speed estimation means is further configured to set, during an energization period of the motor, a value obtained by adding a variation of motor speed per unit time, estimated at a current execution cycle, to a motor speed, estimated immediately before switching to energization of the motor, as the estimated motor speed.

14. The brake control apparatus as claimed in claim 13, wherein:
the control unit is configured to have a first threshold value, which is higher than the target motor speed by a first predetermined speed, and a second threshold value, which is less than the target motor speed by a second predetermined speed; and
the control unit is further configured to terminate energization of the motor when the motor speed estimated by the motor speed estimation means exceeds the first threshold value during an energization period of the motor, and also configured to start energization of the motor when the motor speed estimated by the motor speed estimation means becomes less than the second threshold value during a de-energization period of the motor.

15. The brake control apparatus as claimed in claim 14, wherein:
the control unit has a de-energization-period motor speed estimation means for estimating a de-energization-period motor speed based on a counter-electromotive force corresponding to a de-energization-period inter-terminal voltage of the motor.

16. The brake control apparatus as claimed in claim 15, wherein:
the motor speed control means is further configured to bring the motor speed estimated by the motor speed estimation means closer to the target motor speed.

17. The brake control apparatus as claimed in claim 15, wherein:
the control unit comprises:
a motor-speed deviation calculation means for calculating a motor-speed deviation between the preset target motor speed and the estimated motor speed; and
the control unit is configured to adjust a duty cycle of a pulse-width modulated signal needed for driving the motor responsively to the calculated motor-speed deviation.

18. A brake control apparatus comprising:
a pump that produces a flow of brake fluid in a hydraulic brake circuit;
a brush-equipped motor that drives the pump; and
a control unit configured to control the brush-equipped motor, the control unit comprising:
(i) an energization-period motor speed estimation part configured to estimate an energization-period motor speed based on an inter-terminal voltage between terminals of the brush-equipped motor and a motor characteristic of the brush-equipped motor; and
(ii) a de-energization-period motor speed estimation part configured to estimate a de-energization-period motor speed based on a counter-electromotive force corresponding to the inter-terminal voltage of the brush-equipped motor,
wherein the control unit is configured to execute switching between energization and de-energization of the brush-equipped motor responsively to information about the motor speeds estimated by the energization-period motor speed estimation part and the de-energization-period motor speed estimation part.

19. The brake control apparatus as claimed in claim 18, wherein:
the control unit is configured to have a first threshold value, which is higher than the target motor speed by a first predetermined speed, and a second threshold value, which is less than the target motor speed by a second predetermined speed; and
the control unit is further configured to terminate energization of the motor when the motor speed estimated by the energization-period motor speed estimation part exceeds the first threshold value during an energization period of the motor, and also configured to start energization of the motor when the motor speed estimated by the de-energization-period motor speed estimation part becomes less than the second threshold value during a de-energization period of the motor.

20. The brake control apparatus as claimed in claim 19, wherein:
the control unit comprises a motor-speed deviation calculation part configured to calculate a motor-speed deviation as a difference between the preset target motor speed and the estimated energization-period motor speed during the motor energization period, and also configured to calculate a motor-speed deviation as a difference between the preset target motor speed and the estimated de-energization-period motor speed during the motor de-energization period; and
the control unit is configured to adjust a duty cycle of a pulse-width modulated signal needed for driving the motor responsively to information about the calculated energization-period motor-speed deviation and the calculated de-energization-period motor-speed deviation.
